(19) United States
(12) Patent Application Publication
(10) Pub. No.: US 2025/0214859 A1
(43) Pub. Date: Jul. 3, 2025

(54) SOLID ELECTROLYTE PRECURSOR, SOLID ELECTROLYTE, AND METHOD OF PREPARING SAME SOLID ELECTROLYTE

(71) Applicant: Samsung Electronics Co., Ltd., Suwon-si (KR)

(72) Inventors: Giyun Kwon, Suwon-si (KR); Hyeokjo Gwon, Suwon-si (KR); Jusik Kim, Suwon-si (KR); Gabin Yoon, Suwon-si (KR); Changhoon Jung, Suwon-si (KR)

(21) Appl. No.: 18/984,275

(22) Filed: Dec. 17, 2024

(30) Foreign Application Priority Data
Dec. 28, 2023 (KR) 10-2023-0195359

(51) Int. Cl. C01G 25/00; H01M 10/052; H01M 10/0562

(52) U.S. Cl. CPC C01G 25/006; H01M 10/052; H01M 10/0562; C01P 2002/30; C01P 2002/72; C01P 2002/88; C01P 2006/40; H01M 2300/0077

(57) ABSTRACT

A solid electrolyte precursor, a solid electrolyte, and a method of preparing the solid electrolyte. The solid electrolyte precursor includes a compound represented by Formula 1 and has an amorphous phase and the amorphous phase is contained in an amount of at least 50 volume percent based on the total volume of the solid electrolyte precursor. When the solid electrolyte precursor is analyzed by X-ray diffraction using Cu Kα radiation at a diffraction angle of 10° 2θ to 90° 2θ, a proportion of an area P_{b} of peaks having a full width at half maximum of 0.01° to 0.5° to a total area Pₐ of all peaks is 10% or less:

(LiₓAₐ)(La_{y}B′_{b})(Zr_{z}C′_{c})O_{12+δ}.

### CROSS-REFERENCE TO RELATED APPLICATION

This application is based on and claims priority to Korean Patent Application No. 10-2023-0195359, filed on Dec. 28, 2023, in the Korean Intellectual Property Office, and all the benefits accruing therefrom under 35 U.S.C. § 119, the content of which is herein incorporated by reference in its entirety.

### BACKGROUND

### 1. Field

The disclosure relates to a solid electrolyte precursor, a solid electrolyte, and a method of preparing the solid electrolyte.

### 2. Description of the Related Art

Garnet oxide solid electrolytes can have a high ionic conductivity. When used in an oxide all-solid battery, garnet oxide solid electrolytes can have excellent chemical stability with lithium. However, synthesizing garnet oxide solid electrolytes typically requires a heat-treatment process at a temperature of about 900° C. or greater. A heat treatment process at such high temperatures, due to evaporation of lithium, and so forth can make it difficult to ensure the preparation of garnet oxide solid electrolytes with a crystalline phase such as a pure cubic phase.

To address the aforementioned issues, methods to lower a sintering temperature by introducing various sintering agents have been used. However, the use of sintering agents can generally only partially improve the sintering temperatures, and when a device using a common garnet oxide solid electrolyte is used together with a different material, there may be additional interface formations and side reactions.

Therefore, there remains a need for an improved solid electrolyte precursor, a solid electrolyte using the same, and a method of preparing the solid electrolyte.

### SUMMARY

Provided is a novel solid electrolyte precursor.

Provided is a solid electrolyte derived from the solid electrolyte precursor.

Provided is a method of preparing the solid electrolyte.

Additional aspects will be set forth in part in the description which follows and, in part, will be apparent from the description, or may be learned by practice of the presented embodiments of the disclosure.

According to an aspect of the disclosure, a solid electrolyte precursor includes a compound represented by Formula 1, has an amorphous phase and the amorphous phase is contained in an amount of at least 50 volume percent based on a total volume of the solid electrolyte precursor, and when the solid electrolyte precursor is analyzed by X-ray diffraction using Cu Kα radiation at a diffraction angle of 10° 2θ to 90° 2θ, a proportion of the area P_{b} of peaks having a full width at half maximum of 0.01° to 0.5° to a total area Pₐ of all peaks is 10% or less:

(LiₓAₐ)(La_{y}B′_{b})(Zr_{z}C′_{c})O_{12+δ} Formula 1

In Formula 1, A is a monovalent cation, a divalent cation, a trivalent cation, or a combination thereof, B′ is a monovalent cation, a divalent cation, a trivalent cation, or a combination thereof, C′ is a monovalent cation, a divalent cation, a trivalent cation, a tetravalent cation, a pentavalent cation, a hexavalent cation, or a combination thereof, and 6≤x≤8, 0≤a≤2, 2≤y≤3, 0≤b≤1, 0<z≤2, 0≤c≤2, and −1≤δ≤1.

According to an embodiment, at a diffraction angle of 10° 2θ to 90° 2θ in the X-ray diffraction (XRD) spectrum, the proportion of the area P_{b} of peaks having a full width at half maximum of 0.01° to 0.5° to the total area Pₐ of all peaks may be 1% or less.

According to an embodiment, an exothermic peak may be observed at a temperature of 600° C. or less when the solid electrolyte precursor is analyzed by differential scanning calorimetry (DSC).

According to an embodiment, when analyzed by differential scanning calorimetry, a phase change from an amorphous structure to a garnet crystal structure may be observed at a temperature of 600° C. or less.

According to an embodiment, the garnet crystal structure may include 8-coordinated dodecahedral BO₈ and 6-coordinated octahedral CO₆, and in the garnet crystal structure, a Li site and an A site may each independently be a tetrahedral interstitial site, an octahedral interstitial site, a distorted 4-coordinated interstitial site, or a combination thereof.

According to an embodiment, a compound represented by Formula 1 may include a compound represented by Formula 2:

(LiₓAₐ)(La_{y}B′_{b})(Zr_{z}C′_{c})O_{12+δ} Formula 2

In Formula 2, A may be a trivalent cation, B′ may be one or more selected from Ca, Sr, Ce, and Ba, C′ may be one or more selected from Al, W, Nb, and Ta, and 6≤x≤8, 0≤a≤2, 2≤y≤3, 0≤b≤1, 0<z≤2, 0≤c≤2, and −1≤δ>1.

According to an embodiment, a compound represented by Formula 1 may include a compound represented by Formula 3:

Liₓ(La_{y}B′_{b})(Zr_{z}C′_{c})O_{12+δ} Formula 3

In Formula 3, B′ may be one or more selected from Ca, Sr, Ce, and Ba, C′ may be one or more selected from Al, W, Nb, and Ta, and 6≤x≤8, 0≤a≤2, 2≤y≤3, 0<z≤2, and −1≤δ≤1.

According to an embodiment, a compound represented by Formula 1 may include a compound represented by Formula 4:

Li₆₊ₓLa₃Zr₂₋ₐC′ₐO_{12+δ} Formula 4

In Formula 4, C′ may be Ga, W, Nb, Ta, Al, or a combination thereof, and 0≤x≤2, 0≤a≤0.7, and −1≤δ≤1.

According to an embodiment, the solid electrolyte precursor may be in a powder form.

According to another embodiment, a solid electrolyte including a crystalline product of heat treating the solid electrolyte precursor may be provided.

According to an embodiment, the crystalline phase may include a cubic phase, and the cubic phase may be 60 weight percent (wt %) or greater with respect to a total weight of the crystalline phase.

According to another embodiment, a cathode including the solid electrolyte may be provided.

According to an embodiment, the solid electrolyte may be included in at least one of a cathode layer, an anode layer, and a solid electrolyte layer.

According to an embodiment, a lithium battery includes a solid electrolyte layer between a cathode layer and an anode layer. The cathode layer, the anode layer, the solid electrolyte layer, or a combination thereof include the solid electrolyte.

According to an embodiment, the lithium battery may be a lithium-ion battery, an all-solid battery, or a multilayer ceramic (MLC) battery.

According to another embodiment, a method of preparing a solid electrolyte includes: high-energy mechanical milling on a solid electrolyte precursor including a compound represented by Formula 1 to form a milled product; and heat treating the milled product at a temperature of 600° C. or less to form a solid electrolyte; wherein the solid electrolyte precursor may have an amorphous phase and the amorphous phase is contained in an amount of at least 50 volume percent based on a total volume of the solid electrolyte precursor, and at a diffraction angle of 10° 2θ to 90° 2θ in an X-ray diffraction (XRD) spectrum, the proportion of an area P_{b} of peaks having a full width at half maximum of 0.01° to 0.5° to the total area Pₐ of all peaks is 10% or less.

(LiₓAₐ)(La_{y}B′_{b})(Zr_{z}C′_{c})O_{12+δ} Formula 1

In Formula 1, A is a monovalent cation, a divalent cation, a trivalent cation, or a combination thereof, B′ is a monovalent cation, a divalent cation, a trivalent cation, or a combination thereof, C′ is a monovalent cation, a divalent cation, a trivalent cation, a tetravalent cation, a pentavalent cation, a hexavalent cation, or a combination thereof, and 6≤x≤8, 0≤a≤2, 2≤y≤3, 0≤b≤1, 0<z≤2, 0≤c≤2, and −1≤δ≤1.

According to an embodiment, the high-energy mechanical milling may be performed by high-energy ball-milling.

According to an embodiment, the high-energy mechanical milling may be performed for about 2 hours to about 15 hours.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a graph illustrating intensity (arbitrary units, a.u.) versus diffraction angle (2θ) of the X-ray diffraction spectra of (mixed) solid electrolyte precursors prepared in Comparative Examples 1 and 2 and Examples 2, 4, and 5;

FIG. 2 is a graph illustrating intensity (arbitrary units, a.u.) versus diffraction angle (2θ) of the X-ray diffraction spectrum of solid electrolyte precursors prepared in Examples 1, 2, and 3;

FIG. 3 is a graph illustrating heat flow (arbitrary units, a.u.) versus temperature (° C.) of the differential scanning calorimetry (DSC) spectra of the solid electrolyte precursors prepared in Comparative Example 1 and Examples 1, 2, and 3;

FIG. 4 is a graph illustrating intensity (arbitrary units, a.u.) versus diffraction angle (2θ) of the X-ray diffraction spectra obtained from solid electrolytes prepared using the solid electrolyte precursors prepared in Comparative Example 1 and Example 3, respectively.

FIG. 5 is a schematic diagram of a structure of a lithium-ion battery according to an embodiment;

FIG. 6 is a schematic diagram of a structure of a lithium-ion battery according to another embodiment;

FIG. 7 is a schematic diagram of a structure of a lithium-ion battery according to another embodiment;

FIG. 8 is a schematic cross-sectional diagram of a structure of an all-solid battery according to an embodiment;

FIG. 9 is a schematic cross-sectional diagram of a structure of an all-solid battery according to another embodiment;

FIG. 10 is a schematic cross-sectional diagram of a structure of an all-solid battery according to another embodiment;

FIG. 11 is a schematic cross-sectional diagram of a structure of a multilayer ceramic battery according to an embodiment;

FIG. 12 is a schematic cross-sectional diagram of a structure of a multilayer ceramic battery according to another embodiment; and

FIG. 13 is a schematic cross-sectional diagram of a structure of a multilayer ceramic battery according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept, which will be more fully described hereinafter, may have various variations and various embodiments, and specific embodiments will be illustrated in the accompanied drawings and described in greater detail. However, the present inventive concept should not be construed as being limited to specific embodiments set forth herein. Rather, these embodiments are to be understood as encompassing all variations, equivalents, or alternatives included in the scope of the present inventive concept.

It will be understood that when an element is referred to as being “on” another element, it can be directly on the other element or intervening elements may be present therebetween. In contrast, when an element is referred to as being “directly on” another element, there are no intervening elements present.

The terminology used hereinbelow is used for the purpose of describing particular embodiments only, and is not intended to limit the present inventive concept. As used herein, the singular forms are intended to include the plural forms as well, unless the context clearly indicates otherwise.

Expressions such as “at least one of” or “one or more”, when preceding a list of elements, modify the entire list of elements and do not modify the individual elements of the list. As used herein, the term “combination” includes a mixture, an alloy, a reaction product, and the like, unless otherwise indicated. As used herein, the terms “comprises” and/or “comprising,” or “includes” and/or “including” “includes”, unless otherwise indicated, specify the presence of an element or/and component, but do not preclude the presence or addition of one or more other elements or/and components. As used herein, terms “first”, “second”, and the like are used to distinguish one component from another, without indicating order, quantity, or importance. An expression used in the singular, such as “a” or “an,” encompasses the expression of the plural, unless otherwise indicated or it has a clearly different meaning in the context. The term “or” refers to “and/or” unless otherwise stated.

As used herein, the terms “an embodiment”, “embodiments”, and the like indicate that elements described with regard to an embodiment are included in at least one embodiment described in this specification and may or may not present in other embodiments. In addition, it may be understood that the described elements are combined in any suitable manner in various embodiments.

Unless stated otherwise, all percentages, parts, ratios, etc., are by weight. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed.

Where a range of numerical values is recited herein, unless otherwise stated, the range is intended to include the endpoints thereof, and all integers and fractions within the range. It is not intended that the scope of the invention be limited to the specific values recited when defining a range.

Unless otherwise defined, the unit “parts by weight” refers to a weight ratio between components, and the unit “parts by mass” refers to a value obtained by converting a weight ratio between components based on solids.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The term “about” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, the term “about” can mean within one or more standard deviations, or within ±30%, 20%, 10% or 5% of the stated value.

Unless otherwise defined, all terms (including technical terms and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the present specification and the relevant art and should not be interpreted in an idealized sense unless expressly so defined herein. Furthermore, such terms should not be interpreted in an overly formal sense.

Example embodiments are described herein with reference to cross section illustrations that are schematic illustrations of idealized examples. As such, variations from the shapes of the illustrations as a result, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term “metal” as used herein refers to both metals and metalloids such as silicon and germanium, in an elemental or ionic state.

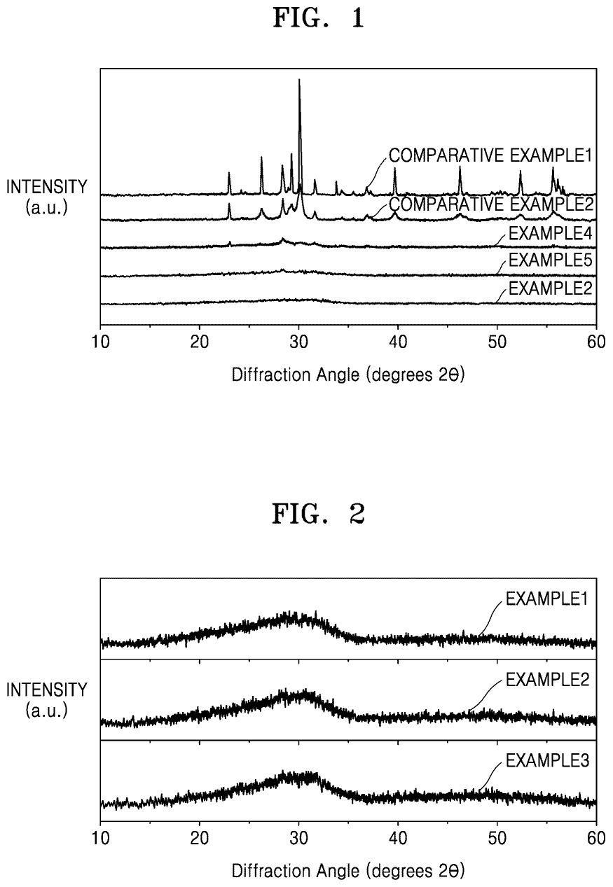

As used herein, “having an amorphous structure as a major phase” means having 50 volume percent (vol %) or greater, 60 vol % or greater, or 70 vol % or greater of an amorphous structure based on a total volume of the solid electrolyte precursor, and means, for example, as shown in FIG. 1 that there is no observable peak in an X-ray diffraction (XRD) spectrum or the main peak in an XRD spectrum has a large full width at half maximum.

As used herein, garnet is a silicate that can be referred to using the formula X₃Y₂(SiO₄)₃, wherein X is a divalent cation, and Y is a trivalent cation. As used herein, the term “garnet crystal structure” means that the garnet crystal structure is isostructural with garnet, e.g., Mg₃Al₂(SiO₄)₃. A garnet oxide solid electrolyte as used herein refers to an oxide solid electrolyte that includes a material with a garnet crystal structure.

A garnet ceramic solid electrolyte as used herein refers to an ceramic solid electrolyte that includes a material with a garnet crystal structure.

Garnet oxide solid electrolytes typically require a heat-treatment process at a temperature of about 900° C. or greater. To lower the temperature of such a high-temperature heat-treatment, various methods have been employed, such as controlling the composition of solid electrolyte, reducing the thicknesses of layers, using a sol-gel process, and the like. Despite these variations, garnet oxide solid electrolytes generally still require a high synthesis temperature.

To address some of the aforementioned issues, a solid electrolyte precursor for a garnet oxide solid electrolyte synthesizable at a low temperature, a solid electrolyte, and a method of preparing the solid electrolyte are disclosed.

Hereinbelow, a solid electrolyte precursor, a solid electrolyte, and a method for preparing the solid electrolyte will be described in greater detail according to embodiments.

### Solid Electrolyte Precursor and Solid Electrolyte

A solid electrolyte precursor according to an embodiment may include a compound represented by Formula 1:

(LiₓAₐ)(La_{y}B′_{b})(Zr_{z}C′_{c})O_{12+δ}. Formula 1

In Formula 1, A may be a monovalent cation, a divalent cation, a trivalent cation, or a combination thereof, B′ may be a monovalent cation, a divalent cation, a trivalent cation, or a combination thereof, C′ may be a monovalent cation, a divalent cation, a trivalent cation, a tetravalent cation, a pentavalent cation, a hexavalent cation, or a combination thereof, and 6≤x≤8, 0≤a≤2, 2≤y≤3, 0≤b≤1, 0<z≤2, 0≤c≤2, and −1≤δ≤1.

In A, B′, and C′ in Formula 1, the monovalent cation may include one or more of Li, Na, or K. The divalent to hexavalent cations may include, for example, one or more of Mg, Ca, Sr, Sc, Y, La, Ce, Pr, Nd, Sm, Eu, Gd, Tb, Dy, Ho, Er, Tm, Yb, Lu, Zr, Hf, V, Nb, Ta, Mo, W, Mn, Tc, Re, Fe, Ru, Os, Co, Rh, Ir, Ni, Pd, Pt, Cu, Ag, Au, Zn, Cd, Hg, Al, Ga, In, TI, Ge, Sn, Pb, Sb, Bi, Po, As, Se, or Te.

In Formula 1, x may be 6.1≤x≤8, 6.3≤x≤8, 6.5≤x≤8, 6.7≤x≤8, 6.9≤x≤8, 7.1≤x≤8, or 7.3≤x≤8.

In Formula 1, a may be 0≤a≤2, 0.5≤a≤1.8, 0.7≤a≤1.8, or 1≤a≤2.

In Formula 1, y may be 2≤y≤3, 2.3≤y≤3, 2.5≤y≤3, or 2.7≤y≤3.

According to an embodiment, a compound represented by Formula 1 may include a compound represented by Formula 2:

(LiₓAₐ)(La_{y}B′_{b})(Zr_{z}C′_{c})O_{12+δ}. Formula 2

In Formula 2, A may be a trivalent cation, B′ may be one or more of Ca, Sr, Ce, or Ba, C′ may be one or more of Al, W, Nb, or Ta, and 6≤x≤8, 0≤a≤2, 2≤y≤3, 0≤b≤1, 0<z≤2, 0≤c≤2, and −1≤0≤1.

According to an embodiment, a compound represented by Formula 1 above may include a compound represented by Formula 3 below:

Liₓ(La_{y}B′_{b})(Zr_{z}C′_{c})O_{12+δ}. Formula 3

In Formula 3, B′ may be one or more of Ca, Sr, Ce, or Ba, C′ may be one or more of Al, W, Nb, or Ta, and 6≤x≤8, 0≤a≤2, 2≤y≤3, 0<z≤2, and −1≤δ≤1.

According to an embodiment, a compound represented by Formula 1 may include a compound represented by Formula 4:

Li₆₊ₓLa₃Zr₂₋ₐC′ₐO_{12+δ}. Formula 4

In Formula 4, C′ may be Ga, W, Nb, Ta, Al, or a combination thereof, and 0≤x≤2, 0≤a≤0.7, and −1≤δ≤1.

A solid electrolyte precursor including a compound represented by Formula 1 according to an embodiment may have an amorphous structure as a major phase and when the solid electrolyte precursor is analyzed by X-ray diffraction (XRD) using Cu Kα radiation at a diffraction angle of 10° 2θ to 90° 2θ, a proportion of the area P_{b} of peaks having a full width at half maximum of 0.01° to 0.5° to the total area Pₐ of all peaks may be 10% or less.

According to an embodiment, when the solid electrolyte precursor is analyzed by XRD using Cu Kα radiation at a diffraction angle of 10° 2θ to 90° 2θ, the proportion of the area P_{b} of peaks having a full width at half maximum of 0.01° to 0.5° to the total area Pₐ of all peaks may be 1% or less.

Because atoms constituting the solid electrolyte precursor are randomly arranged, an application of even a low temperature may facilitate the synthesis of a crystalline solid electrolyte by providing a driving force for crystallization.

According to an embodiment, the solid electrolyte precursor may show a phase change from an amorphous structure to a garnet crystal structure at a temperature of 600° C. or less with the solid electrolyte precursor is analyzed by differential scanning calorimetry (DSC). Unlike the synthesis of conventional garnet oxide solid electrolytes, the solid electrolyte precursor undergoes a phase change to a crystalline phase at a temperature of 600° C. or less, and therefore may be more easily used in the synthesis of a crystalline solid electrolyte.

A garnet crystal structure may include 8-coordinated dodecahedral BO₈ and 6-coordinated octahedral CO₆, and in the garnet crystal structure a Li site and an A site may be each independently a tetrahedral interstitial site, an octahedral interstitial site, or a distorted 4-coordinated interstitial site.

According to an embodiment, a solid electrolyte precursor may have a powder form. The solid electrolyte precursor having a powder form may be prepared by application of mechanochemical energy (e.g., mechanical milling).

A solid electrolyte according to another embodiment may include a crystalline phase originating from the aforementioned solid electrolyte precursor.

According to an embodiment, the crystalline phase may include a cubic phase, and the cubic phase may be 60 wt % or greater with respect to the total weight of the crystalline phase.

According to an embodiment, the crystalline phase may include a cubic phase and a tetragonal phase. The amount of the tetragonal phase, with respect to the total amount of the crystalline phase, may be less than 10 wt %, or about 1 wt % to about 10 wt %, for example, about 5 wt % to about 10 wt %. The amount of the tetragonal phase with respect to the total amount of the crystalline phase may be less than 10 wt %, about 1 wt % to about 10 wt %, or about 5 wt % to about 10 wt %. With the amount of the tetragonal phase within the aforementioned ranges, excellent ionic conductivity may be obtained. The solid electrolyte is not limited to any particular form, but may have a particulate form. The particulate form may be a spherical particle or a non-spherical particle. The solid electrolyte in the particulate form may be molded into various shapes. The formed solid electrolyte may have, for example, a sheet form or a pellet form.

### Lithium Battery

A cathode according to another embodiment may include the aforementioned solid electrolyte.

In a lithium battery according to another embodiment, the aforementioned solid electrolyte may be included in at least one of a cathode layer, an anode layer, and a solid electrolyte layer.

The aforementioned solid electrolyte may include a crystalline phase originated from a solid electrolyte precursor that includes a compound represented by Formula 1that has an amorphous phase as a major phase, and when the solid electrolyte precursor is analyzed by XRD using Cu Kα radiation at a diffraction angle of 10° 20 to 90° 20, the proportion of the area P_{b} of peaks having a full width at half maximum of 0.01° to 0.5° to the total area Pₐ of all peaks is 10% or less.

If a lithium battery contains the aforementioned solid electrolyte, the internal resistance of the lithium battery may be reduced and the cycling performance of the lithium battery may improve. The lithium battery is not particularly limited and may be, for example, a lithium-ion battery, an all-solid battery, a multilayer ceramic (MLC) battery, a lithium air battery, or the like.

According to another embodiment, a cathode layer may include a garnet ceramic solid electrolyte including a crystalline phase and an amorphous phase, and a solid electrolyte layer may include a crystalline phase originated from a solid electrolyte precursor that includes a compound represented by Formula 1, has an amorphous structure as a major phase, and when the solid electrolyte precursor is analyzed by X-ray diffraction using Cu Kα radiation at a diffraction angle of 10° 2θ to 90° 2θ, the proportion of the area P_{b} of peaks having a full width at half maximum of 0.01° to 0.5° to the total area Pα of all peaks is 10% or less.

According to an embodiment, the solid electrolyte layer may have a thickness of about 0.1 micrometers (μm) to about 500 μm, or about 1 μm to about 200 μm, for example, about 1 μm to about 80 μm. With the solid electrolyte layer having a thickness in the aforementioned ranges, the solid electrolyte layer may have improved ionic conductivity while having excellent mechanical strength.

If the solid electrolyte according to an embodiment is used to manufacture a lithium battery, highly uniform interfacial characteristics between the solid electrolyte and the cathode layer may be ensured.

These batteries will be described in greater detail below.

### Lithium-Ion Battery

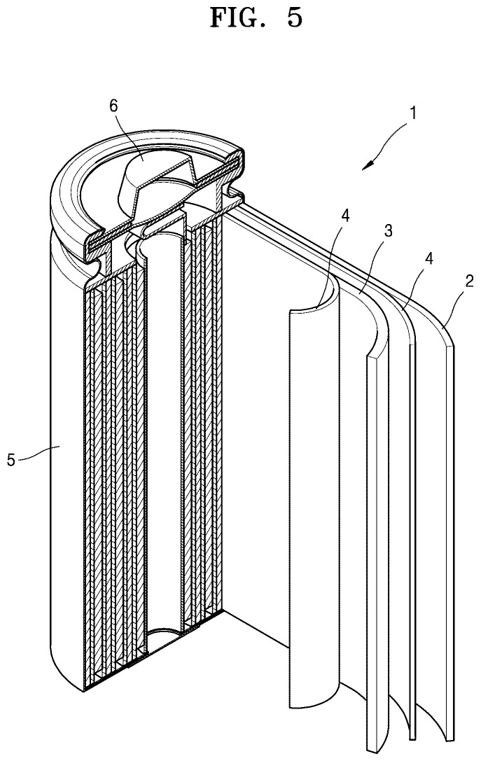

FIGS. 5 to 7 are a schematic diagram of a lithium-ion battery according to embodiments.

The lithium-ion battery may be, for example, a lithium battery containing a liquid electrolyte. The lithium-ion battery may include a solid electrolyte including a crystalline phase originated from a solid electrolyte precursor that includes a compound represented by Formula 1, has an amorphous phase as a major phase, and when the solid electrolyte precursor is analyzed by XRD using Cu Kα radiation at a diffraction angle of 10° 2θ to 90° 2θ, the proportion of the area P_{b} of peaks having a full width at half maximum of 0.01° to 0.5° to the total area Pₐ of all peaks is 10% or less.

A lithium-ion battery may include, for example, a cathode including a cathode active material; an anode including an anode active material; and a liquid electrolyte disposed between the cathode and the anode, wherein one or more of the cathode and the anode may include a solid electrolyte including a crystalline phase originated from a solid electrolyte precursor, which includes a compound represented by Formula 1, has an amorphous phase as a major phase, and when the solid electrolyte precursor is analyzed by XRD using Cu Kα radiation at a diffraction angle of 10° 2θ to 90° 2θ, the proportion of the area P_{b} of peaks having a full width at half maximum of 0.01° to 0.5° to the total area Pₐ of all peaks is 10% or less. A lithium-ion battery may include, for example, a cathode, an anode, and a liquid electrolyte disposed between the cathode and the anode, wherein one or more of the cathode and the anode may include a protective layer on one side thereof, wherein the protective layer includes a solid electrolyte including a crystalline phase originated from a solid electrolyte precursor, which includes a compound represented by Formula 1, has an amorphous phase as a major phase, and when the solid electrolyte precursor is analyzed by XRD using Cu Kα radiation at a diffraction angle of 10° 2θ to 90° 2θ, the proportion of the area P_{b} of peaks having a full width at half maximum of 0.01° to 0.5° to the total area Pₐ of all peaks is 10% or less. A lithium-ion battery may include, for example, a cathode active material layer, wherein the cathode active material layer may include a composite cathode active material including a core including a cathode active material; and a first coating layer disposed on the core, wherein the first coating layer may include a solid electrolyte including a crystalline phase originated from a solid electrolyte precursor, which has an amorphous structure as a major phase and when the solid electrolyte precursor is analyzed by XRD using Cu Kα radiation at a diffraction angle of 10° 2θ to 90° 2θ, the proportion of the area P_{b} of peaks having a full width at half maximum of 0.01° to 0.5° to the total area Pₐ of all peaks is 10% or less. A lithium-ion battery may include, for example, an anode active material layer, wherein the anode active material layer may include a composite anode active material including a core including an anode active material; and a second coating layer disposed on the core, wherein the second coating layer may include a solid electrolyte including a crystalline phase originated from a solid electrolyte precursor, which has an amorphous structure as a major phase and when the solid electrolyte precursor is analyzed by XRD using Cu Kα radiation at a diffraction angle of 10° 2θ to 90° 2θ, the proportion of the area P_{b} of peaks having a full width at half maximum of 0.01° to 0.5° to the total area Pₐ of all peaks is 10% or less.

A lithium-ion battery may be prepared as follows, for example.

First, a cathode may be prepared. A cathode active material layer-forming composition may be prepared by mixing a cathode active material, a conductive material, a binder, and a solvent. A cathode may be prepared by having the cathode active material layer-forming composition directly applied and dried on a cathode current collector. Alternatively, a cathode may be prepared by casting the cathode active material layer-forming composition onto a separate support, and then laminating a film exfoliated from the support onto a cathode current collector. In some embodiments, the cathode active material layer-forming composition may be prepared as an electrode ink containing an excess amount of a solvent, and then printed on a support by an ink-jet method or a Gravure printing method to thereby prepare a cathode. The printing method is not limited to the aforementioned methods, and may be any method available for general coating and printing.

One surface of the cathode active material layer included in the cathode may be coated with a solid electrolyte originated from a solid electrolyte precursor including a compound represented by Formula 1, thereby forming a cathode protective layer. Alternatively, solid electrolyte particles originated from a solid electrolyte precursor including a compound represented by Formula 1 may be added to the cathode active material layer-forming composition and thereby included within the cathode active material layer.

The cathode current collector may include a metal substrate. The metal substrate may utilize, for example, a plate, a foil, etc. formed of aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. The cathode current collector may be omitted. The cathode current collector may further include a carbon layer disposed on one side or both sides of a metal substrate. With the carbon layer further disposed on the metal substrate, it may be possible to protect metals in the metal substrate from corrosion by a solid electrolyte included in the cathode and reduce the interfacial resistance between the cathode active material layer and the cathode current collector. The carbon layer may have a thickness of, for example, about 0.1 μm to about 5 μm, about 0.1 μm to about 3 μm, or about 0.1 μm to about 1 μm. If the thickness of the carbon layer is excessively thin, it may be difficult to completely prevent the metal substrate and the solid electrolyte from coming in contact with each other. If the carbon layer is excessively thick, the energy density of an all-solid secondary battery may decrease. The carbon layer may include amorphous carbon, crystalline carbon, and the like.

For the cathode active material, any cathode active material commonly used in lithium batteries may be utilized without any limitation. For example, the cathode active material may be a lithium transition metal oxide, a transition metal sulfide, or the like. For example, the cathode active material may utilize one or more composite oxides of lithium with a metal selected from cobalt, manganese, nickel, and a combination thereof. Specifically, the cathode active material may utilize any one compound represented by the following formulas: LiₐA′_{1-b}B′_{b}D′₂ (in the formula, 0.90≤a≤1.8 and 0≤b≤0.5); LiₐE′_{1-b}B′_{b}O_{2-c}D′_{c} (in the formula, 0.90≤a≤1.8, 0≤b≤0.5, and 0≤c≤0.05); LiE′_{2-b}B′_{b}O_{4-c}D′_{c} (in the formula, 0≤b≤0.5 and 0≤c≤0.05); LiₐNi_{1-b-c}CO_{b}B′_{c}D′_{α} (in the formula, 0.90≤a≤1.8, 0≤b≤0.5, 0≤c≤0.05, and 0<α≤2); LiₐNi_{1-b-c}Co_{b}B′_{c}O_{2-α}F′_{α} (in the formula, 0.90≤a≤1.8, 0≤b≤0.5, 0≤c≤0.05, and 0<α<2); LiₐNi_{1-b-c}Co_{b}B′_{c}O_{2-α}F′₂ (in the formula, 0.90≤a≤1.8, 0≤b≤0.5, 0≤c≤0.05, and 0<α<2); LiₐNi_{1-b-c}Mn_{b}B′_{c}D′_{α} (in the formula, 0.90≤a≤1.8, 0≤b≤0.5, 0≤c≤0.05, and 0<α≤2); LiₐNi_{1-b-c}Mn_{b}B′_{c}O_{2-α}F′_{α} (in the formula, 0.90≤a≤1.8, 0≤b≤0.5, 0≤c≤0.05, and 0<α<2); LiₐNi_{1-b-c}Mn_{b}B′_{c}O_{2-α}F′₂ (in the formula, 0.90≤a≤1.8, 0≤b≤0.5, 0≤c≤0.05, and 0<α<2); LiₐNi_{b}E′_{c}G′_{d}O₂ (in the formula, 0.90≤a≤1.8, 0≤b≤0.9, 0≤c≤0.5, and 0.001≤d≤0.1); LiₐNi_{b}Co_{c}Mn_{d}G′ₑO₂ (in the formula, 0.90≤a≤1.8, 0≤b≤0.9, 0≤c≤0.5, 0≤d≤0.5, and 0.001≤e≤0.1); LiₐNiG′_{b}O₂ (in the formula, 0.90≤a≤1.8, 0.001≤b≤0.1); LiₐCoG′_{b}O₂ (in the formula, 0.90≤a≤1.8 and 0.001≤b≤0.1); LiₐMnG′_{b}O₂ (in the formula, 0.90≤a≤1.8 and 0.001≤b≤0.1); LiₐMn₂G′_{b}O₄ (in the formula, 0.90≤a≤1.8 and 0.001≤b≤0.1); Q′O₂; Q′S₂; LiQ′S₂; V₂O₅; LiV₂O₂; LiI′O₂; LiNiVO₄; Li_{(3-f)}J′₂(PO₄)₃ (0≤f≤2); Li_{(3-f)}Fe₂(PO₄)₃ (0≤f≤2); and LiFePO₄. In the formulas above, A′ may be nickel (Ni), cobalt (Co), manganese (Mn), or a combination thereof; B′ may be aluminum (Al), Ni, Co, Mn, chromium (Cr), iron (Fe), magnesium (Mg), strontium (Sr), vanadium (V), a rare earth element, or a combination thereof; D′ may be oxygen (O), fluorine (F), sulfur(S), phosphorus (P), or a combination thereof; E′ may be Co, Mn, or a combination thereof; F′ may be F, S, P, or a combination thereof; G′ may be Al, Cr, Mn, Fe, Mg, lanthanum (La), cerium (Ce), Sr, V, or a combination thereof; Q′ may be titanium (Ti), molybdenum (Mo), Mn, or a combination thereof; I′ may be Cr, V, Fe, Sc, yttrium (Y), or a combination thereof; and J′ may be V, Cr, Mn, Co, Ni, copper (Cu), or a combination thereof. For example, the cathode active material may include LiCoO₂, LiMnₓO₂ₓ (x=1, 2), LiNi₁₋ₓMnₓO₂ₓ (0<x<1), Ni_{1-x-y}CoₓMn_{y}O₂ (0≤x≤0.5, 0≤y≤0.5), LiFePO₄, TiS₂, FeS₂, TiS₃, FeS₃, and the like. A surface of the cathode active material may be coated with a conductive composition to suppress side reactions between the cathode active material and the electrolyte.

The conductive material may include, for example, carbon black, carbon fibers, graphite, or a combination thereof. The carbon black may be, for example, acetylene black, Ketjen black, Super P carbon, channel black, furnace black, lamp black, thermal black, or a combination thereof. The graphite may be natural graphite or artificial graphite. A combination containing at least one of the aforementioned conductive materials may be used. The cathode may further include an additional conductive material other than the aforementioned carbonaceous conductive materials. Examples of the additional conductive material may include electrically conductive fibers, such as metal fibers; metal powder such as fluorinated carbon powder, aluminum powder, or nickel powder; conductive whiskers such as zinc oxide and potassium titanate; or polyethylene derivatives. A combination of one or more of the aforementioned conductive materials may be used. The amount of the conductive material with respect to 100 parts by weight of the cathode active material may be about 1 part by weight to about 10 parts by weight, or about 2 parts by weight to about 7 parts by weight. If the amount of the conductive material is within such a range, for example, in a range of about 1 part by weight to about 10 parts by weight, the cathode may have a suitable electrical conductivity. The conductive material may have a conductivity of at least 10⁻² siemens per centimeter.

A binder may improve adhesion between cathode components, and adhesion of the cathode to the current collectors. Examples of the binder may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene), polyethylene, polypropylene, ethylene-propylene-diene monomer (EPDM), sulfonated EPDM, styrene-butadiene-rubber, fluorinated rubber, a copolymer of the aforementioned examples, or a combination thereof. The amount of the binder with respect to 100 parts by weight of the cathode active material may be about 1 part by weight to about 10 parts, or about 2 parts by weight to about 7 parts by weight. If the amount of the binder is within the aforementioned ranges, the adhesion of the cathode active material layer to the cathode current collector may be further improved such that a decrease in the energy density of the cathode active material layer can be suppressed.

N-methylpyrrolidone, acetone, and/or water may be utilized as a solvent. Each of the cathode active material, the conductive material, the binder, and the solvent may be used in an amount commonly used in a lithium battery.

It may be possible to create pores within the cathode active material layer by adding a plasticizer to the cathode active material composition.

Next, an anode may be prepared. An anode active material layer-forming composition may be prepared by mixing an anode active material, a conductive material, a binder, and a solvent. An anode may be prepared by having the anode active material layer-forming composition directly applied and dried on a copper current collector. In some embodiments, an anode may be prepared by casting the anode active material layer-forming composition on a separate support, and then having an anode active material film exfoliated from the support laminated on the copper current collector. In some embodiments, the anode active material layer-forming composition may be prepared as an electrode ink containing an excess amount of a solvent, and then printed on a support by an ink-jet method or a Gravure printing method to thereby prepare an anode. Without being limited to the aforementioned methods, the printing may utilize any method available for use in general coating and printing.

The anode active material may include, for example, one or more of lithium metal, a lithium metal alloy, a metal alloyable with lithium, a transition metal oxide, a non-transition metal oxide, or a carbon-containing material. The lithium metal alloy may be an alloy of lithium with another metal, such as indium. Examples of the metal alloyable with lithium include Si, Sn, Al, Ge, Pb, Bi, Sb, an Si—Y′ alloy (Y′ is an alkali metal, an alkaline earth metal, a Group 13 element, a Group 14 element, a transition metal, a rare-earth element, or a combination thereof, but is not Si), an Sn—Y′ alloy (Y′ is an alkali metal, an alkaline earth metal, a Group 13 element, a Group 14 element, a transition metal, a rare-earth element, or a combination thereof, but is not Sn), or the like. Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. Examples of the transition metal oxide include a lithium-titanium oxide, a vanadium oxide, a lithium-vanadium oxide, and the like. Examples of the non-transition metal may be SnO₂, SiOₓ (0<x<2), or the like. The carbon-containing material may be, for example, crystalline carbon, amorphous carbon, or a mixture thereof. Examples of the crystalline carbon include graphite, such as artificial graphite or natural graphite in shapeless, plate, flake, spherical or fiber form. Examples of the amorphous carbon include soft carbon (low-temperature calcined carbon) or hard carbon, mesophase pitch carbides, calcined cokes, or the like. The anode active material layer may be, for example, lithium metal, a lithium metal alloy, or a combination thereof.

The conductive material, binder, and solvent used in the preparation of the anode may be selected from materials used in the preparation of a cathode plate. Each of the anode active material, the conductive material, the binder, and the solvent may be used in an amount commonly used in a lithium battery.

It may be possible to create pores within the anode active material layer by adding a plasticizer to the anode active material layer-forming composition.

A protective layer including a solid electrolyte originated from a solid electrolyte precursor including a compound represented by Formula 1 may be disposed on one side of the anode active material layer. Alternatively, the anode active material may include anode active material particles including a core including lithium metal, a lithium alloy, or a combination thereof; and a first coating layer disposed on the core, wherein the coating layer may include a solid electrolyte originated from a solid electrolyte precursor including a compound represented by Formula 1. With such a protective layer and/or coating layer disposed on the anode, the anode may have improved lithium-ion conductivity and/or stability with lithium metal. Alternatively, solid electrolyte particles originated from a solid electrolyte precursor including a compound represented by Formula 1 may be added to the anode active material layer-forming composition and thereby included within the anode active material layer. Next, a separator may be prepared.

The cathode and the anode may be separated by a separator, wherein the separator may be any separator commonly used in a lithium battery. For the separator, any separator capable of retaining a large quantity of electrolytes while exhibiting low resistance to ion migration in electrolytes may be suitable. For example, the separator may be in the form of non-woven fabric or woven fabric, formed of a material selected from glass fibers, polyester, Teflon, polyethylene, polypropylene, polytetrafluoroethylene (PTFE), or a combination thereof. More particularly, a lithium-ion battery may utilize, for example, a rollable separator formed of polyethylene, polypropylene, or the like, and a lithium-ion polymer battery may utilize, for example, a separator capable of retaining a large quantity of organic electrolytes.

The separator may be prepared by the method described below. Once a separator composition is prepared by mixing a polymer resin, a filler, and a solvent, the separator composition may be directly coated and dried on an electrode to form a separator film. Alternatively, the separator may be formed by casting and drying the separator composition on a support and then laminating a separator film exfoliated from the support on an electrode. The polymer resin is not particularly limited and may utilize any material available as a binder of an electrode plate. For example, the polymer resin may utilize a vinylidene fluoride/hexafluoropropylene copolymer, polyvinylidene fluoride, polyacrylonitrile, polymethyl methacrylate, or a mixture thereof. It may be preferable to use a vinylidene fluoride/hexafluoropropylene copolymer having a hexafluoropropylene content of about 8 wt % to about 25 wt %.

The separator may further include a solid electrolyte originated from a solid electrolyte precursor including a compound represented by Formula 1. For example, a coating layer including a solid electrolyte originated from a solid electrolyte precursor including a compound represented by Formula 1 may be added on at least one side of the separator. Because the separator further includes the coating layer, the heat resistance and dimensional stability of the separator may further improve. The separator may include, for example, a porous substrate; and a coating layer disposed on one side or both sides of the porous substrate, wherein the coating layer may include a solid electrolyte derived from a solid electrolyte precursor including a compound represented by Formula 1.

Next, a liquid electrolyte may be prepared.

The liquid electrolyte may be an organic electrolyte containing an organic solvent. The organic electrolyte may be prepared by dissolving a lithium salt in an organic solvent. For the organic solvent, any or all organic solvents available in the art may be utilized. The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof. For the lithium salt, any or all lithium salts available in the art may be utilized. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are different from each other and each independently an integer of 1 to 20), LiCl, LiI, or a mixture thereof. The amount of the lithium salt may be about 0.1 moles per liter (M) to about 10 M or about 0.1 M to about 5 M, but without being necessarily limited to the aforementioned ranges, may be appropriately adjusted within a range that provides improved battery performance. The liquid electrolyte may further include a flame retardant, such as a phosphorus-based flame retardant or a halogen-based flame retardant.

Referring to FIG. 5, a lithium-ion battery 1 according to embodiments may include a cathode 3, the aforementioned anode 2, and a separator 4. The cathode 3, the anode 2, and the separator 4 may be wound or folded to form a battery structure. The formed battery structure may be accommodated in the battery case 5. The battery case 5 may be injected with a cathode electrolyte-forming composition, followed by crosslinking, and then sealed with a cap assembly 6 to complete the lithium-ion battery 1. The battery case 5 may be a cylindrical type, but without being necessarily limited thereto, may be a prismatic type, a thin-film type, and the like.

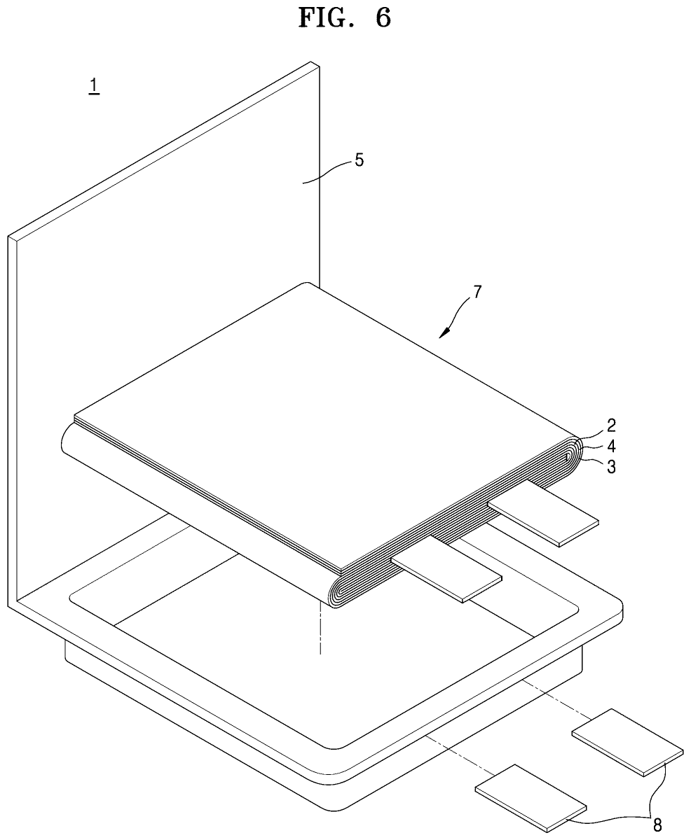

Referring to FIG. 6, a lithium battery 1 according to an embodiment may include a cathode 3, the aforementioned anode 2, and a separator 4. The separator 4 may be disposed between the cathode 3 and the anode 2, and the cathode 3, the anode 2, and the separator 4 may be wound or folded to form the battery structure 7. The battery structure 7 thus formed may be accommodated in the battery case 5. An electrode tab 8, acting as an electrical path for guiding an electrical current generated in the battery structure 7 to the outside, may be included. A cathode electrolyte-forming composition may be injected into the battery case 5, followed by crosslinking and then, the battery case 5 may be sealed to complete the lithium-ion battery 1. The battery case 5 may have a polygonal shape, but without being necessarily limited thereto, may also have a cylindrical shape, a thin-film shape, and the like, for example.

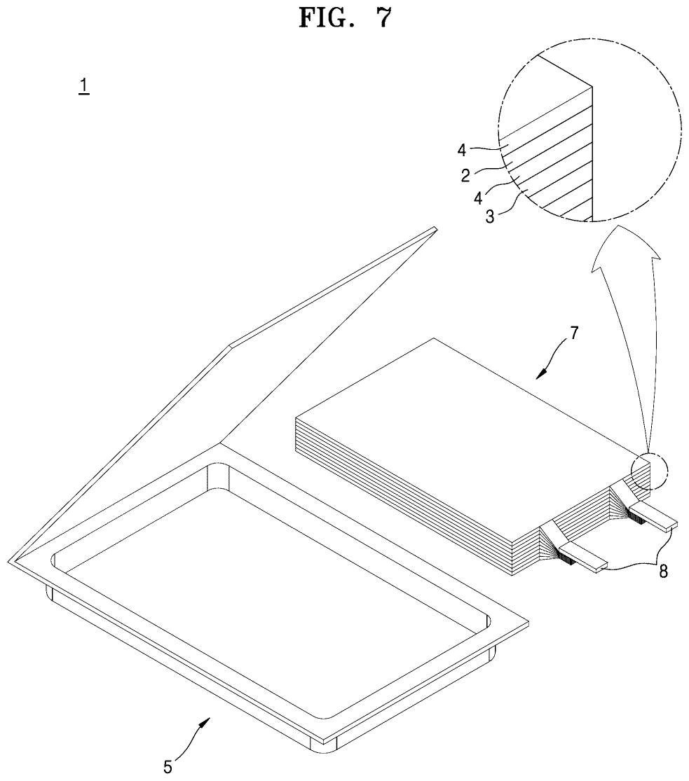

Referring to FIG. 7, a lithium battery 1 according to an embodiment may include a cathode 3, the aforementioned anode 2, and a separator 4. The separator 4 may be disposed between the cathode 3 and the anode 2, thereby forming a battery structure. The battery structure 7 may be stacked in a bi-cell structure and then accommodated in the battery case 5. An electrode tab 8, acting as an electrical path for guiding an electrical current generated in the battery structure 7 to the outside, may be included. A cathode electrolyte-forming composition may be injected into the battery case 5, followed by crosslinking, and then, the battery case 5 may be sealed to complete the lithium-ion battery 1. The battery case 5 may have a polygonal shape, but without being necessarily limited thereto, may also have a cylindrical shape, a thin-film shape, and the like, for example.

A pouch-type lithium-ion battery may be a lithium-ion battery shown in FIGS. 5 to 7, using a pouch as the case. The pouch-type lithium-ion battery may include more than one battery structure. A separator may be placed between the cathode and the anode to form a battery structure. A plurality of battery structures may be stacked in a thickness direction, immersed in an organic electrolyte, and then accommodated and sealed in a pouch, to thereby form a pouch-type lithium-ion battery. For example, although not illustrated in the drawings, the aforementioned cathode, anode, and separator described above may be simply stacked and then accommodated in a pouch as an electrode assembly, or may be wound or folded as a jelly roll-type electrode assembly and then accommodated in a pouch. Subsequently, a cathode electrolyte-forming composition may be injected into a pouch, followed by crosslinking and sealing, to complete a lithium-ion battery.

The lithium-ion battery, due to its excellent discharge capacity and lifespan characteristics and high energy density, may be utilized in, for example, an electric vehicle (EV). For example, the lithium battery may be used in a hybrid vehicle, such as a plug-in hybrid electric vehicle (PHEV) and the like. Also, the lithium battery may be used in any field that requires a large amount of energy storage. For example, the lithium battery may be used in an electric bicycle, a power tool, and the like.

Multiple units of the lithium-ion battery may be stacked together to form a battery module, and multiple units of the battery module may form a battery pack. Such a battery pack may be utilized in all types of devices in which high capacity and high output are required. For example, the battery pack may be used in a laptop computer, a smartphone, an electric vehicle, or the like. The battery module may include, for example, a plurality of batteries and a frame holding the batteries. The battery pack may include, for example, a plurality of battery modules and a bus bar connecting the battery modules. The battery module and/or the battery pack may further include a cooling device. A plurality of battery packs may be controlled by a battery management system. The battery management system may include a battery pack, and a battery control device connected to the battery pack.

### All-Solid Battery

An all-solid battery may be, for example, a battery containing a solid electrolyte. The all-solid battery may include a solid electrolyte originated from a solid electrolyte precursor including a compound represented by Formula 1.

An all-solid battery may include, for example, a cathode containing a cathode active material; an anode containing an anode active material; and a solid electrolyte layer disposed between the cathode and the anode, wherein at least one of the cathode, the anode, and the solid electrolyte layer may include a solid electrolyte originated from a solid electrolyte precursor including a compound represented by Formula 1. The all-solid battery may include, for example, a cathode active material layer, and the cathode active material layer may include a solid electrolyte originated from a solid electrolyte precursor including a compound represented by Formula 1. The all-solid battery may include, for example, an anode active material layer, and the anode active material layer may include a solid electrolyte originated from a solid electrolyte precursor including a compound represented by Formula 1. The all-solid battery may include a solid electrolyte layer disposed between a cathode and an anode, wherein the solid electrolyte layer may include a solid electrolyte derived from a solid electrolyte precursor including a compound represented by Formula 1. An all-solid battery may include, for example, a cathode active material layer, wherein the cathode active material layer may include a core including a cathode active material; and a composite cathode active material including a first coating layer disposed on the core, wherein the first coating layer may include a solid electrolyte derived from a solid electrolyte precursor including a compound represented by Formula 1. An all-solid battery may include, for example, an anode active material layer, wherein the anode active material layer may include a core including an anode active material; and a composite anode active material including a second coating layer disposed on the core, wherein the second coating layer may include a solid electrolyte derived from a solid electrolyte precursor including a compound represented by Formula 1.

### Type 1: All-Solid Battery with Non-Plated Type Anode

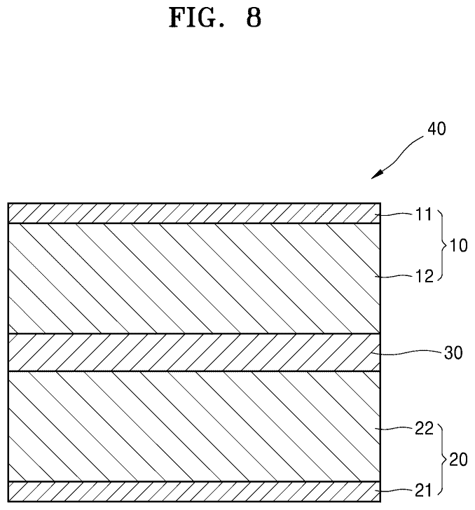

FIG. 8 is a schematic diagram of an all-solid battery including a non-plated type anode according to an embodiment. In the all-solid battery including a non-plated type anode, during the initial charging, the initial charge capacity of the anode active material layer may be, for example, greater than 50%, 60% or greater, 70% or greater, 80% or greater, 90% or greater, or 100% or greater, of the initial charge capacity of the cathode active material layer.

An all-solid type lithium battery may be prepared as follows.

First, a solid electrolyte layer may be prepared. The solid electrolyte layer may include a solid electrolyte. For the solid electrolyte layer, for example, a solid electrolyte originated from a solid electrolyte precursor including a compound represented by Formula 1 and a binder may be mixed and dried to produce the solid electrolyte layer. Alternatively, solid electrolyte powder originated from a solid electrolyte precursor including a compound represented by Formula 1 may be pressed into a specific form to produce the solid electrolyte layer. For the solid electrolyte layer, for example, a solid electrolyte originated from a solid electrolyte precursor including a compound represented by Formula 1, a sulfide and/or oxide solid electrolyte, and a binder may be mixed together and dried to produce the solid electrolyte layer. Alternatively, solid electrolyte powder originated from a solid electrolyte precursor including a compound represented by Formula 1 and sulfide and/or oxide solid electrolyte powder may be pressed into a specific form to produce the solid electrolyte layer. For example, the solid electrolyte layer may be prepared by mixing and drying sulfide and/or oxide solid electrolytes and a binder, or may be prepared by pressing sulfide and/or oxide electrolyte powder into a specific form.

For example, the solid electrolyte may be deposited using a film formation method, thereby forming a solid electrolyte layer, wherein the film formation method may be by blasting, aerosol deposition, cold spraying, sputtering, chemical vapor deposition, spraying, or the like. Additionally, the solid electrolyte layer may be formed by pressing the solid electrolyte. Additionally, the solid electrolyte layer may be formed by mixing and pressing a solid electrolyte, a solvent, and a binder or support. In this case, the solvent or support may be added to reinforce the strength of the solid electrolyte layer or to prevent a short-circuit of the solid electrolyte.

The binder included in the solid electrolyte layer may be, for example, styrene butadiene rubber (“SBR”), polytetrafluoroethylene, polyvinylidene fluoride, polyethylene, polyvinyl alcohol, or the like, but without being limited to the aforementioned materials, any binder available in the art may be used. The binder in the solid electrolyte layer may be the same as or different from the binders in the cathode layer and the anode layer.

The oxide-based solid electrolyte may be, for example, one or more of Li_{1+x+y}AlₓTi₂₋ₓSi_{y}P_{3-y}O₁₂ (0<x<2 and 0≤y<3), BaTiO₃, Pb(ZrₐTi₁₋ₐ)O₃ (0≤a≤1) (“PZT”), Pb₁₋ₓLaₓZr_{1-y}Ti_{y}O₃ (“PLZT”) (0≤x<1 and 0≤y<1), PB(Mg₃Nb_{2/3})O₃—PbTiO₃ (“PMN-PT”), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2 and 0<y<3), LiₓAl_{y}Ti_{z}(PO₄)₃ (0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (0≤x≤1, 0≤y≤1, 0≤a≤1, and 0≤b≤1), LiₓLa_{y}TiO₃ (0<x<2 and 0<y<3), Li₂O, LiOH, Li₂CO₃, LiAlO₂, Li₂O—Al₂O₃—SiO₂—P₂O₅—TiO₂—GeO₂, or Li₃₊ₓLa₃M₂O₁₂ (M is Te, Nb, or Zr, and x is an integer of 1 to 10). The solid electrolyte may be produced by methods such as a sintering method. The oxide solid electrolyte may be, for example, a garnet solid electrolyte selected from Li₇La₃Zr₂O₁₂ (“LLZO”) and Li₃₊ₓLa₃Zr₂₋ₐMₐO₁₂ (“M-doped LLZO”, M is Ga, W, Nb, Ta, or Al, and x is in a range of 1 to 10).

Examples of the sulfide solid electrolyte may include lithium sulfide, silicon sulfide, phosphorus sulfide, boron sulfide, or a combination thereof. Sulfide solid-state electrolyte particles may include Li₂S, P₂S₅, SiS₂, GeS₂, B₂S₃, or a combination thereof. The sulfide solid-state electrolyte particles may be Li₂S or P₂S₅. The sulfide solid electrolyte particles are known to have a higher lithium-ion conductivity than other inorganic compounds. For example, the sulfide solid electrolyte may include Li₂S, P₂S₅, or a combination thereof. If sulfide solid electrolyte materials constituting the solid electrolyte include Li₂S—P₂S₅, the mixing molar ratio of Li₂S to P₂S₅ may be, for example, in a range of about 50:50 to about 90:10.

The sulfide solid electrolyte may also include inorganic solid electrolytes that are prepared by adding Li₃PO₄, a halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“ThioLISICON”), Li₂O—Al₂O₃—TiO₂—P₂O₅ (“LATP”) or the like, to an inorganic solid electrolyte of Li₂S—P₂S₅, SiS₂, GeS₂, B₂S₃, or a combination thereof.

Non-limiting examples of the sulfide solid electrolyte materials include Li₂S—P₂S₅; Li₂S—P₂S₅—LiX (X is a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (m and n are each a positive number, and Z is Ge, Zn, or Ga); Li₂S—GeS₂; Li₂S—SiS₂—Li₃PO₄; or Li₂S—SiS₂—LiₚMO_{q} (wherein p and q are each a positive number, and M is P, Si, Ge, B, Al, Ga, or In). In this regard, the sulfide solid electrolyte material may be prepared by subjecting a starting material (e.g., Li₂S, P₂S₅, etc.) of the sulfide solid electrolyte material to a treatment, such as melt quenching, mechanical milling, and the like. In addition, a calcination process may be performed following the above treatment.

In some embodiments, the sulfide solid electrolyte may be, among the sulfide solid electrolyte materials described above, a material that contains at least sulfur(S), phosphorus (P), and lithium (Li), as its constitutive elements. For example, the sulfide solid electrolyte may be a material including Li₂S—P₂S₅. If a material including Li₂S—P₂S₅ is used as a sulfide solid electrolyte material, the mixing molar ratio of Li₂S to P₂S₅ may be, for example, in a range of about 50:50 to about 90:10.

The sulfide solid electrolyte may be a compound having an argyrodite crystal structure. The compound having an argyrodite crystal structure may include, for example, one or more of Li₇₋ₓPS₆₋ₓClₓ (0<x<2), Li₇₋ₓPS₆₋ₓBrₓ (0<x<2), or Li₇₋ₓPS₆₋ₓIₓ (0<x<2). The sulfide solid electrolyte included in the solid electrolyte may be an argyrodite compound including one or more Li₆PS₅Cl, Li₆PS₅Br, or Li₆PSₛI. As used herein, argyrodite is a silver germanium sulfide mineral that can be referred to using the formula Ag₈GeS₆. As used herein, the term “argyrodite crystal structure” means that the crystal structure is isostructural with argyrodite. In the disclosure, the term “isostructural” refers to crystal structures of chemical compounds. The crystal structures are the same, but the cell dimensions and/or the chemical composition may not be the same. An “argyrodite compound” as used herein includes a material with an argyrodite crystal structure.

Next, a cathode may be prepared.

The cathode may be prepared by having a cathode active material layer including a cathode active material formed on a cathode current collector. The cathode active material layer may be prepared by a vapor-state reaction method or a solid-state reaction method. The vapor-state reaction method may include methods such as pulse laser deposition (PLD), sputtering deposition, and chemical vapor deposition (CVD), but without being limited to the aforementioned methods, any method available in the art may be used. The solid-state reaction method may include methods such as sintering, a sol-gel technique, a doctor blade technique, screen printing, slurry casting, and powder pressing, but without being limited to the aforementioned methods, any method available in the art may be used.

The cathode active material layer may include a cathode active material. The cathode active material and cathode current collector may be selected from the aforementioned materials used in a lithium-ion battery.

The cathode active material layer may further include a binder, a conductive material, and the like. The binder and conductive material may be selected from the aforementioned materials used in a lithium-ion battery.

The cathode active material layer may include a solid electrolyte originated from a solid electrolyte precursor including a compound represented by Formula 1. In the cathode active material layer, the amount of the solid electrolytes may be about 5 parts by weight to about 40 parts by weight, about 5 parts by weight to about 39 parts by weight, or about 10 parts by weight to about 35 parts by weight based on the total weight of the cathode active material layer. A protective layer including a solid electrolyte originated from a solid electrolyte precursor including a compound represented by Formula 1 may be disposed on the cathode active material layer.

Next, an anode may be prepared.

The anode may be prepared in the same manner as the cathode except that an anode active material is used in place of the cathode active material. The anode may be prepared by having an anode active material layer including an anode active material formed on an anode current collector.

The anode active material layer may include an anode active material. The anode active material may be selected from the aforementioned materials used in the lithium-ion battery. The anode active material layer may be, for example, lithium metal, a lithium metal alloy, or a combination thereof.

The anode active material layer may further include a binder, a conductive material, and the like. The binder and conductive material may be selected from the aforementioned materials used in a lithium-ion battery.

The anode active material layer may include a solid electrolyte originated from a solid electrolyte precursor including a compound represented by Formula 1. A protective layer including a solid electrolyte originated from a solid electrolyte precursor including a compound represented by Formula 1 may be disposed on the anode active material layer.

Referring to FIG. 8, an all-solid battery 40 may include a solid electrolyte layer 30, a cathode 10 disposed on one side of the solid electrolyte layer 30, and an anode 20 disposed on the other side of the solid electrolyte layer 30. The cathode 30 may include a cathode active material layer 12 in contact with the solid electrolyte layer 30, and a cathode current collector 11 in contact with the cathode active material layer 12. The anode 20 may include an anode active material layer 22 in contact with the solid electrolyte layer 30, and an anode current collector 21 in contact with the anode active material layer 22. For the all-solid battery 40, for example, the cathode active material layer 12 and the anode active material layer 22 may be formed on each side of the solid electrolyte layer 30, and the cathode current collector 11 and the anode current collector 21 may be formed on the cathode active material layer 12 and the anode active material layer 22, respectively, to thereby complete the preparation of an all-solid secondary battery 30. Alternatively, the anode active material layer 22, the solid electrolyte layer 30, the cathode active material layer 12, and the cathode current collector 11 may be sequentially laminated on the anode current collector 21, to thereby complete the preparation of the all-solid secondary battery 40.

### Type 2: All-Solid Battery with Plated-Type Anode

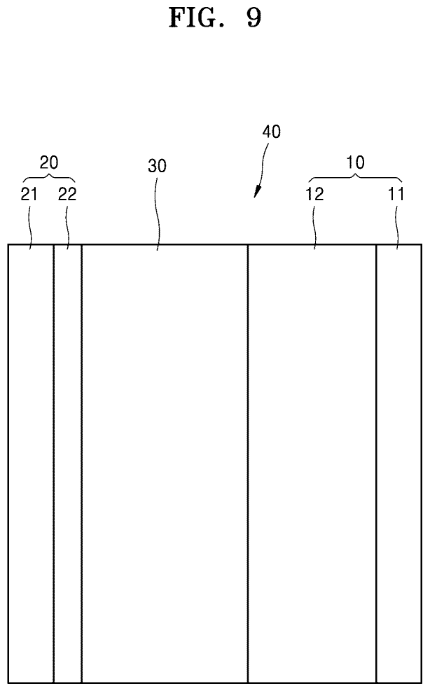

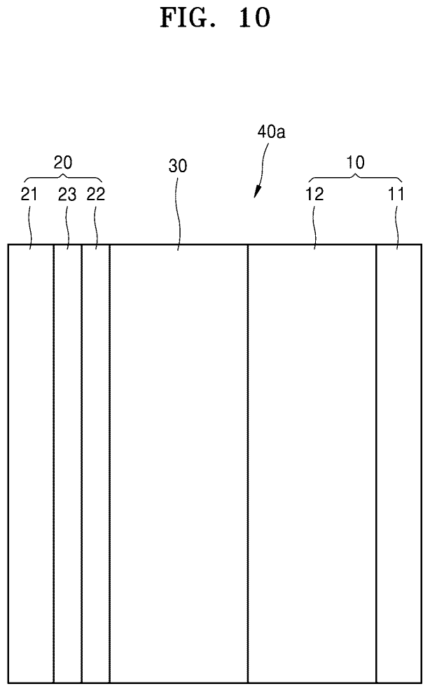

FIGS. 9 and 10 are schematic diagrams of an all-solid battery including a plated-type anode according to an example embodiment. In the all-solid battery including a plated-type anode, during the initial charging, the initial charge capacity of the anode active material layer may be, for example, 50% or less, 40% or less, 30% or less, 20% or less, 10% or less, 5% or less, or 1% or less, of the initial charge capacity of the cathode active material layer. The all-solid battery 40 may include, for example, the cathode layer 10 including the cathode active material layer 12 disposed on the cathode current collector 11; the anode layer 20 including the anode active material layer 12 disposed on the anode current collector 21; and the solid electrolyte layer 30 disposed between the cathode layer 10 and the anode layer 20, wherein the cathode active material layer 12 and/or the solid electrolyte layer 30 may include a solid electrolyte.

An all-solid battery according to another embodiment may be prepared as follows.

The cathode and solid electrolyte layer may be prepared following the same process as in the solid-state secondary battery provided with the non-plated type anode described above.

Next, an anode may be prepared.

Referring to FIGS. 9 and 10, an anode 20 may include an anode current collector 21 and an anode active material layer 22 disposed on the anode current collector 21, wherein the anode active material layer 22 may include, for example, an anode active material and a binder.

The anode active material included in the anode active material layer 22 may have, for example, a particulate form. The anode active material having a particulate form may have an average particle diameter of, for example, 4 μm or less, 3 μm or less, 2 μm or less, 1 μm or less, or 900 nm or less. The average particle diameter of the anode active material having a particulate form may be, for example, from about 10 nanometers (nm) to about 4 μm, about 10 nm to about 3 μm, about 10 nm to about 2 μm, about 10 nm to about 1 μm, or about 10 nm to 900 nm or less. With the anode active material having an average particle diameter within the above ranges, reversible absorption and/or desorption of lithium during charging/discharging may be facilitated. The average particle diameter of the anode active material may be, for example, a median particle diameter (D50) as measured by a laser-type particle size distribution analyzer.

The anode active material included in the anode active material layer 22 may include, for example, at least one of a carbon-containing anode active material, a metal, or a metalloid anode active material.

The carbon-containing anode active material may be, for example, an amorphous carbon. Examples of the amorphous carbon include carbon black (CB), acetylene black (AB), furnace black (FB), Ketjen black (KB), graphene, or the like; however, the carbon-containing anode active material is not limited to the aforementioned examples and may be any material that is categorized as amorphous carbon in the art. Amorphous carbon is carbon with no crystalline structure or with an extremely low degree of crystallinity and as such, may be distinct from crystalline carbon or graphitic carbon.

The metal or metalloid anode active material may include one or more of gold (Au), platinum (Pt), palladium (Pd), silicon (Si), silver (Ag), aluminum (AI), bismuth (Bi), tin (Sn), or zinc (Zn), but without being limited thereto, may be any material in the art that is used as a metal anode active material or a metalloid anode active material that forms an alloy or a compound with lithium. For example, nickel (Ni) does not form an alloy with lithium and is therefore not regarded as a metal anode active material.

The anode active material layer 22 may include a single anode active material, or a mixture of multiple different types of anode active materials among the aforementioned anode active materials. For example, the anode active material layer 22 may include amorphous carbon alone, or may include one or more of gold (Au), platinum (Pt), palladium (Pd), silicon (Si), silver (Ag), aluminum (AI), bismuth (Bi), tin (Sn), or zinc (Zn). In some embodiments, the anode active material layer 22 may include a mixture of amorphous carbon with one or more of gold (Au), platinum (Pt), palladium (Pd), silicon (Si), silver (Ag), aluminum (AI), bismuth (Bi), tin (Sn), or zinc (Zn). The mixing ratio of amorphous carbon to the metal(s) described herein, such as gold (Au) in such a mixture, may be, by weight, for example, about 10:1 to about 1:2, about 5:1 to about 1:1, or about 4:1 to about 2:1, but without being necessarily limited thereto, may be selected according to a required feature of the all-solid battery 40. Because the anode active material has the aforementioned compositions, the cycling performance of the all-solid battery 40 may further improve.

The anode active material included in the anode active material layer 22 may include, for example, a mixture of first particles and second particles, the first particles being composed of amorphous carbon, and the second particles being composed of a metal or a metalloid. Examples of the metal or metalloid include gold (Au), platinum (Pt), palladium (Pd), silicon (Si), silver (Ag), aluminum (AI), bismuth (Bi), tin (Sn), zinc (Zn), or the like. In other embodiments, the metalloid may be a semiconductor. The amount of the second particles may be about 8 wt % to about 60 wt %, about 10 wt % to about 50 wt %, about 15 wt % to about 40 wt %, or about 20 wt % to about 30 wt %, of the total weight of the mixture. If the amount of the second particles is within the aforementioned ranges, for example, the cycling performance of the all-solid battery 40 may further improve.

The binder included in the anode active material layer 22 may be, for example, styrene butadiene rubber (SBR), polytetrafluoroethylene, polyvinylidene fluoride, polyethylene, a vinylidene fluoride/hexafluoropropylene copolymer, polyacrylonitrile, polymethylmethacrylate, or the like. However, the binder is not limited to the aforementioned examples and may be any material available as a binder in the art. The binder may be composed of a single type of binder, or multiple binders of different types.

Because the anode active material layer 22 includes a binder, the anode active material layer 22 may be stabilized on the anode current collector 21. Further, crack formation in the anode active material layer 22 may be suppressed, despite volume changes and/or displacement of the anode active material layer 22 during charging and discharging processes. For example, if the anode active material layer 22 does not contain any binder, the anode active material layer 22 may be easily delaminated from the anode current collector 21. At an area where the anode current collector 21 is exposed as a result of delamination of the anode active material layer 22 from the anode current collector 21, the anode current collector 21 may come in contact with the solid electrolyte layer 30, thus increasing the likelihood of a short circuit occurring. For example, the anode active material layer 22 may be prepared by applying and drying a slurry having dispersed therein materials forming the anode active material layer 22 on the anode current collector 21. By including a binder in the anode active material layer 22, stable dispersion of the anode active materials within the slurry may be achieved. For example, if the slurry is to be applied onto the anode current collector 21 by a screen-printing method, it may be possible to prevent the screen from clogging (for example, clogging by agglomerates of the anode active material).

The anode active material layer 22 may further include other additives used in a conventional all-solid battery, such as a filler, a coating agent, a dispersing agent, an ionically conductive aid, or the like.

For example, the anode active material layer 22 may have a thickness of 50% or less, 40% or less, 30% or less, 20% or less, 10% or less, or 5% or less, of a thickness of the cathode active material layer 12. For example, the anode active material layer 22 may have a thickness of about 1 μm to about 20 μm, about 2 μm to about 10 μm, or about 3 μm to about 7 μm. If the anode active material layer 22 is excessively thin, the anode active material layer 22 may be disintegrated by lithium dendrites formed between the anode active material layer 22 and the anode current collector 21, thus making it difficult to improve the cycling performance of the all-solid battery 40. If the thickness of the anode active material layer 22 is excessively thick, the energy density of the all-solid battery 40 may decrease while the internal resistance of the all-solid battery 40 by the anode active material layer 22 increases, thus making it difficult to improve the cycling performance of the all-solid battery 40.

If the thickness of the anode active material layer 22 decreases, for example, the charge capacity of the anode active material layer 22 also decreases. For example, the charge capacity of the anode active material layer 22 may be 50% or less, 40% or less, 30% or less, 20% or less, 10% or less, 5% or less, and 2% or less, or 1% or less, of the total charge capacity of the cathode active material layer 12. The charge capacity of the anode active material layer 22 may be, for example, about 0.1% to about 50%, about 0.1% to about 40%, about 0.1% to about 30%, about 0.1% to about 20%, about 0.1% to about 10%, about 0.1% to about 5%, or about 0.1% to about 2%, of the total charge capacity of the cathode active material layer 12. If the initial charge capacity of the anode active material layer 22 is excessively small, the thickness of the anode active material layer 22 becomes extremely small, and thus, the anode active material layer 22 may be disintegrated by lithium dendrites formed between the anode active material layer 22 and the anode current collector 21 during repeated charging/discharging processes, thus making it difficult to improve the cycling performance of the all-solid battery 40. If the charge capacity of the anode active material layer 22 is excessively thick, the energy density of the all-solid battery 40 may decrease while the internal resistance of the all-solid battery 40 by the anode active material layer 22 increases, thus making it difficult to improve the cycling performance of the all-solid battery 40.

The charge capacity of the cathode active material layer 12 may be obtained by multiplying the charge specific density (milliampere-hours per gram, mAh/g) of a cathode active material by the mass of the cathode active material in the cathode active material layer 12. If multiple types of cathode active materials are used, the product of charge specific density times mass may be calculated for each cathode active material, and the sum of these products may be defined as initial charge capacity of the cathode active material layer 12. The charge capacity of the anode active material layer 22 may also be calculated in the same manner. For example, the charge capacity of the anode active material layer 22 may be obtained by multiplying the charge specific density (mAh/g) of an anode active material by the mass of the anode active material in the anode active material layer 22. If multiple types of anode active materials are used, the product of charge specific density times mass may be calculated for each anode active material, and the sum of these products may be defined as the capacity of the anode active material layer 22. For example, the charge specific density of each of the cathode active material and the anode active material may be a capacity estimated using an all-solid half-cell using lithium metal as counter electrode. By the charge capacity measurement using an all-solid half-cell, the charge capacity of each of the cathode active material layer 12 and the anode active material layer 22 may be directly measured. Charge specific density may be obtained by dividing the measured charge capacity by the mass of the corresponding active material. In other embodiments, the charge capacity of each of the cathode active material layer 12 and the anode active material layer 22 may be the initial charge capacity measured during the first cycle charging.

Referring to FIG. 10, an all-solid battery 40a may further include, for example, a metal layer 23 disposed between an anode current collector 21 and an anode active material layer 22. The metal layer 23 may be a metal foil or a plated metal layer. The metal layer 23 may include lithium or a lithium alloy. Accordingly, the metal layer 23 may act as a lithium reservoir, for example. The lithium alloy may include, for example, a Li—Al alloy, a Li—Sn alloy, a Li—In alloy, a Li—Ag alloy, a Li—Au alloy, a Li—Zn alloy, a Li—Ge alloy, a Li—Si alloy, or the like, but without being limited thereto, may be any material available as a lithium alloy in the art. The metal layer 23 may be composed of lithium or one of such alloys, or may be composed of various types of alloys.

The metal layer 23 is not limited to any particular thickness, but may have a thickness of, for example, about 1 μm to about 200 μm, about 1 μm to about 100 μm, about 1 μm to about 70 μm, about 1 μm to about 50 μm, about 1 μm to about 30 μm, or about 1 μm to about 20 μm. If the metal layer 23 is excessively thin, the metal layer 23 may fail to sufficiently function as a lithium reservoir. If the metal layer 23 is excessively thick, the all-solid battery 40a may have an increased mass and volume and show rather deteriorated cycling performance. The metal layer 23 may be, for example, a metal foil having a thickness in the aforementioned ranges.

In the all-solid battery 40, the metal layer 23 may be, for example, disposed between the anode current collector 21 and the anode active material layer 22 prior to assembly of the all-solid battery 40a, or the metal layer 23 may be plated between the anode current collector 21 and the anode active material layer 22 after assembly of the all-solid battery 40a. In a case in which the metal layer 23 is positioned between the anode current collector 21 and the anode active material layer 22 prior to assembly of the all-solid battery 40a, the metal layer 23, due to being a metal layer containing lithium, may act as a lithium reservoir. For example, prior to assembly of the all-solid battery 40a, a lithium foil may be positioned between the anode current collector 21 and the anode active material layer 22. As a result, the cycling performance of the all-solid battery 40a including the metal layer 23 may further improve. In a case in which the metal layer 23 is to be plated by charging after assembly of the all-solid battery 40a, because the metal layer 23 is absent in the all-solid battery 40a at the time of its assembly, the energy density of the all-solid battery 40a may increase. For example, if charging the all-solid secondary battery 40a, the charging may be performed to exceed the charge capacity of the anode active material layer 22. The anode active material layer 22 may be then overcharged. At the beginning of the charging, lithium may be absorbed into the anode active material layer 22. The anode active material included in the anode active material layer 22 may form an alloy or a compound with lithium ions migrated from the cathode layer 10. Charging to exceed the capacity of the anode active material layer 22 may cause lithium plating, for example, on the back surface of the anode active material layer 22, for example, between the anode current collector 21 and the anode active material layer 22, and the plated lithium then may form a metal layer that corresponds to the metal layer 23. The metal layer 23 may be a metal layer mainly composed of lithium (i.e., metal lithium). This result may be obtained from the fact that the anode active material included in the anode active material layer 22 is constituted of a material that forms an alloy or compound with lithium. During discharge, lithium in metal layers, e.g., the anode active material layer 22 and the metal layer 23, may be ionized and migrate toward the cathode layer 10. Therefore, lithium may be used as an anode active material in the all-solid battery 40a. In some embodiments, the anode active material layer 22 covers the metal layer 23, and as such, may function as a protective layer for a metal layer, e.g., the metal layer 23, while suppressing plating and growth of lithium dendrites. Therefore, short circuits and capacity fading of the all-solid battery 40a may be suppressed, and consequently, the cycling performance of the all-solid battery 40a may improve. Further, in a case in which the metal layer 23 is positioned by charging after assembly of the all-solid battery 40a, the anode current collector 21, the anode active material layer 22, and the region therebetween may be, for example, a Li-free region that does not include lithium (Li) while the all-solid battery 40a is in the initial state or in a state after discharging.

The anode current collector 21 may be formed of a material that does not react with lithium, for example, does not form an alloy or a compound with lithium. Examples of the material forming the anode current collector 21 include copper (Cu), stainless steel, titanium (Ti), iron (Fe), cobalt (Co), nickel (Ni), or the like. However, the material forming the anode current collector 21 is not necessarily limited to the aforementioned materials but may be any material available as an electrode current collector in the art. The anode current collector 21 may be formed of one type of the aforementioned metals, an alloy of two or more types metals thereof, or a covering material. The anode current collector 21 may be, for example, a plate type or a foil type.

The all-solid battery 40, 40a may further include, for example, a thin film (not shown) containing an element capable of forming an alloy with lithium on the anode current collector 21. The thin film may be positioned between the anode current collector 21 and the anode active material layer 22. The thin film may include, for example, an element capable of forming an alloy with lithium. Examples of the element capable of forming an alloy with lithium include gold (Au), silver (Ag), zinc (Zn), tin (Sn), indium (In), silicon (Si), aluminum (AI), bismuth (Bi), or the like, but without being necessarily limited thereto, any element capable of forming an alloy with lithium in the art may be utilized. The thin film may be composed of one of the aforementioned metals or may be composed of an alloy of various kinds of metals.

With the thin film disposed on the anode current collector 21, the form of the metal layer 23 being plated between the thin film 24 and the anode active material layer 22 may be further flattened, and the cycling performance of the all-solid battery 40a may further improve.

For example, the thin film may have a thickness of about 1 nm to about 800 nm, about 10 nm to about 700 nm, about 50 nm to about 600 nm, or about 100 nm to about 500 nm. If the thickness of the thin film is less than 1 nm, it may be difficult to achieve functions attributable to the thin film. If the thin film is excessively thick, the thin film 23 may absorb lithium by itself and thus decrease the amount of lithium plated at the anode, which as a result may decrease the energy density of an all-solid battery and cause the cycling performance of the all-solid battery 40, 40a to deteriorate. The thin film may be positioned on the anode current collectors 21 by a vacuum deposition method, a sputtering method, a plating method or the like, but is not limited to the aforementioned methods and may be any method available in the art that is capable of forming the thin film.

### Multi-Layer Ceramic (MLC) Battery

An MLC battery may include, for example, a plurality of cathode layers; a plurality of anode layers alternately disposed between the plurality of cathode layers; and solid electrolyte layers alternately disposed between the plurality of cathode layers and the plurality of anode layers. The solid electrolyte included in the MLC battery may be, for example, an oxide solid electrolyte. For example, the solid electrolyte may include a solid electrolyte containing a compound represented by Formula 1.

An MLC battery may be, for example, a sintered product of a laminate in which a cathode active material precursor, an anode active material precursor, and a solid electrolyte precursor are sequentially stacked, or may be a sintered product of a laminate in which a cathode active material, an anode active material, and a solid electrolyte are sequentially stacked. An MLC battery may be provided with, for example, a laminated structure in which a plurality of unit cells are stacked with cathode active material layers facing anode active material layers and vice versa, while each unit cell includes a cathode layer including a cathode active material layer; a solid electrolyte layer; and an anode layer including an anode active material layer are sequentially continuously disposed. For example, the MLC battery may further include a cathode current collector and/or an anode current collector. If the MLC battery includes a cathode current collector, a cathode active material layer may be disposed on both sides of the cathode current collector. If the MLC battery includes an anode current collector, an anode active material layer may be disposed on both sides of the anode current collector. When the MLC battery further includes a cathode current collector and/or an anode current collector, the high-rate capability of the battery may further improve. In the MLC battery, unit cells may be stacked together by providing a current collector layer on any one or both of the uppermost layer and the lowermost layer of the laminate, or by inserting a metal layer into the laminate. The MLC battery or thin-film battery may be a small or ultra-small battery that can be applied, for example, as a power source for applications of Internet of Things (IoT) or a power source for wearable devices. The MLC battery or thin film battery may also be applied to medium- to large-sized batteries in an electric vehicle (EV), an energy storage system (ESS), or the like.

The anode included in the MLC battery may include, for example, one or more anode active materials selected from a lithium metal phosphate, a lithium metal oxide, or a metal oxide. The anode active material may be, for example, a compound selected from Li_{4/3}Ti_{5/3}O₄, LiTiO₂, LiM1ₛM2ₜOᵤ (M1 and M2 are each a transition metal, and s, t, and u are each any positive number), TiOₓ (0<x≤3), or LiₓV₂(PO₄)₃ (0<x≤5). The anode active material may be, in particular, Li_{4/3}Ti_{5/3}O₄, LiTiO₂, or the like.

The cathode included in the MLC battery may include a cathode active material. The cathode active material may be selected from the aforementioned cathode active materials used in a lithium-ion battery. The cathode active material may include, for example, one or more of a lithium metal phosphate or a lithium metal oxide. Examples of the cathode active material include lithium cobalt oxide, lithium iron phosphate, lithium nickel cobalt manganese oxide, lithium nickel cobalt aluminum oxide, lithium nickel cobalt manganese aluminum oxide, or a combination thereof.

The current collector layer may function as a cathode current collector and/or an anode current collector. The current collector layer may be, for example, made of any metal selected from Ni, Cu, Ag, Pd, Au, or Pt. The current collector layer may be made of, for example, an alloy containing any one of Ni, Cu, Ag, Pd, Au, or Pt. The alloy may be, for example, an alloy of two or more of Ni, Cu, Ag, Pd, Au, or Pt. The alloy may be, for example, an Ag/Pd alloy. Such a metal and alloy may be a single type or a mixture of two or more types. The current collector layer as cathode current collector and the current collector layer as anode current collector may utilize the same material or a different material from each other. Since an alloy or mixed powder containing Ag and Pd, by adjusting its mixing ratio, can adjust its melting point to any melting point between the melting point of silver (962° C.) and the melting point of palladium (1,550° C.), the melting point may be adjusted to a batch-sintering temperature. In addition, the alloy or mixed powder containing Ag and Pd, due to having high electronic conductivity, may suppress an increase of battery internal resistance.

The solid electrolyte may be, for example, an oxide solid electrolyte. The oxide solid electrolyte may be selected from the aforementioned materials used in the all-solid battery. For example, the solid electrolyte may be a lithium compound selected from Li_{3.25}Al_{0.25}SiO₄, Li₃PO₄, or LiPₓSi_{y}O_{z} (in the formula, x, y, and z each are any positive number). The solid electrolyte may be, for example, Li_{3.5}P_{0.5}Si_{0.5}O₄.

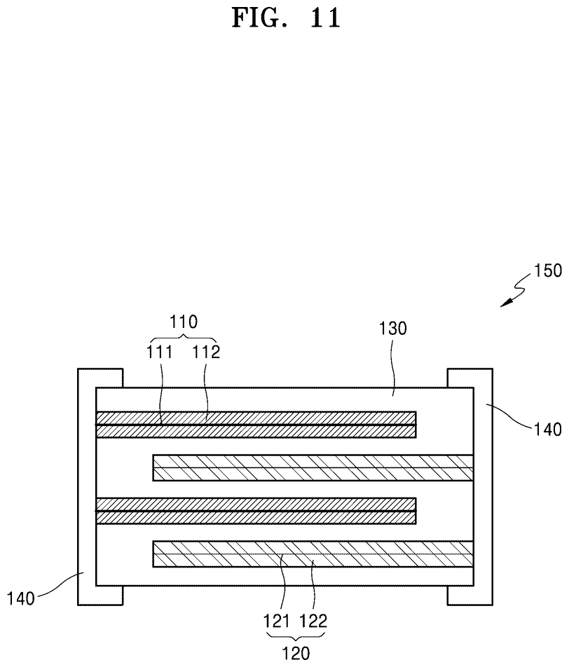

FIG. 11 is a cross-sectional schematic diagram of an MLC battery according to an embodiment. Referring to FIG. 11, a cathode active material layer 112 may be disposed on both sides of a cathode current collector 111 to form a cathode 110. An anode active material layer 122 may be laminated on both sides of an anode current collector 121 to form an anode 120. A solid electrolyte 130 may be disposed between the cathode 110 and the anode 120. An external electrode 140 may be formed on both ends of a battery body 150. The external electrode 140 may be connected to the cathode 110 and the anode 120, each of which has a tip portion exposed outside the battery body 150 and act as an external terminal that electrically connects the cathode 110 and the anode 120 to an external element. One of a pair of external electrodes 140 may have one end thereof connected to the cathode 110 exposed outside the battery body 150, and the other one of the pair of external electrodes 140 may have the other end thereof connected to the anode 120 exposed outside the battery body 150. An MLC battery 150 may be prepared by having an oxide electrode and a solid electrolyte sequentially stacked and then heat-treated at the same time.

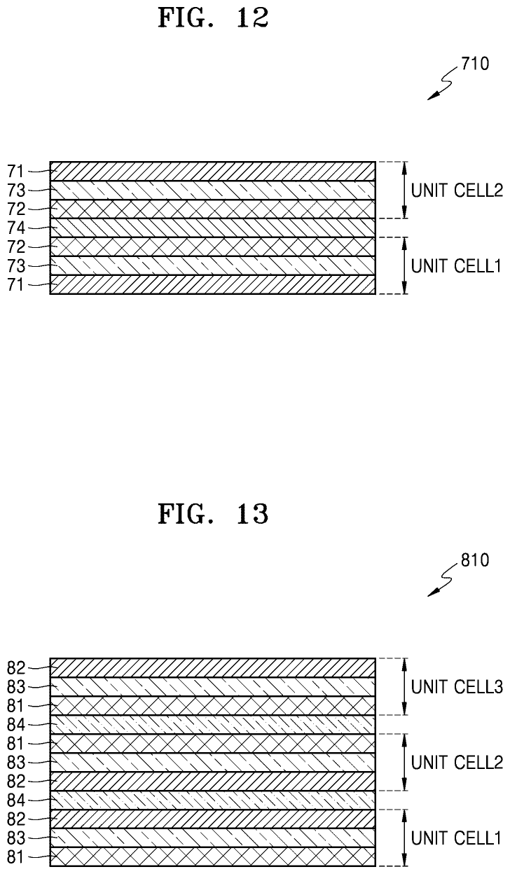

FIGS. 12 and 13 schematically show a cross-sectional structure of a multilayer ceramic battery according to another embodiment. As shown in FIG. 12, in the MLC battery 710, a unit cell 1 and a unit cell 2 may be laminated through an internal current collector layer 74. Each of the unit cell 1 and the unit cell 2 may be composed of a cathode layer 71, a solid electrolyte layer 73, and an anode layer 72, sequentially laminated. The unit cell 1, the unit cell 2, and the inner current collector layer 74 may be laminated such that the anode layer 72 of the unit cell 2 is adjacent to one side of an inner current collector layer 72 (top surface in FIG. 12) and the anode layer 72 of the unit cell 1 is adjacent to the other side of the inner current collector layer 74 (bottom surface in FIG. 12). The inner current collector layer 74, although illustrated in FIG. 12 as being positioned in contact with the anode layer 72 of each of the unit cell 1 and the unit cell 2, may also be positioned in contact with the cathode layer 71 of each of the unit cell 1 and the unit cell 2. The inner current collector layer 74 may include an electronically conductive material. The inner current collector layer 74 may further include an ionically conductive material. Further inclusion of an ionically conductive material may improve voltage stability characteristics. Because both sides of the inner current collector layer 74 has the same polarity in an MLC battery 710, a monopolar-type MLC battery 710, which has a plurality of unit cells connected in parallel to each other by the inner current collector layer 74 inserted therein, may be obtained. As a result, a high-capacity MLC battery 710 may be obtained. Because the inner current collector layer 74 inserted between the unit cell 1 and the unit cell 2 contains an electronically conductive material in the MLC battery 710, a parallel electrical connection between two adjacent unit cells may become possible and at the same time, an ionically conductive connection between the cathode layer 71 or anode layer 72 in two adjacent unit cells may become possible. Because electric potentials of adjacent anode layers 71 or cathode layers 72 can be averaged through the inner current collector layer 74, a stable output voltage may be obtained. In addition, an external current collecting member, such as a tab, may be omitted, and a parallel electrical connection between unit cells constituting the MLC battery 710 may become possible. As a result, the MLC battery 710 having excellent space efficiency and cost-effectiveness may be obtained. Referring to FIG. 13, a laminated structure may contain a cathode layer 81, an anode layer 82, a solid electrolyte layer 83, and an inner current collector layer 84. The laminated structure may be laminated and thermally compressed to form an MLC battery stack 810. The cathode layer 81 may be composed of a single cathode layer sheet, and the anode layer 82 may be composed of two anode layer sheets.

### Method of Preparing Solid Electrolyte

A method of preparing a solid electrolyte according to another embodiment may include: high-energy mechanical milling on a solid electrolyte precursor including a compound represented by Formula 1 to form a milled product; and heat treating the milled product at a temperature of 600° C. or less to form a solid electrolyte, wherein the solid electrolyte precursor has an amorphous phase as a major phase and when the solid electrolyte precursor is analyzed by XRD using Cu Kα radiation at a diffraction angle of 10° 2θ to 90° 2θ, the proportion of the area P_{b} of peaks having a full width at half maximum of 0.01° to 0.5° to the total area Pₐ of all peaks may be 10% or less:

(LiₓAₐ)(La_{y}B′_{b})(Zr_{z}C′_{c})O_{12+δ}. Formula 1

In Formula 1, A may be a monovalent cation, a divalent cation, a trivalent cation, or a combination thereof, B′ may be a monovalent cation, a divalent cation, a trivalent cation, or a combination thereof, C′ may be a monovalent cation, a divalent cation, a trivalent cation, a tetravalent cation, a pentavalent cation, a hexavalent cation, or a combination thereof, and 6≤x≤8, 0≤a≤2, 2≤y≤3, 0≤b≤1, 0<z≤2, 0≤c≤2, and −1≤δ≤1.

The high-energy mechanical milling (HEMM) refers to a process of forming materials into a complex by application of mechanical energy.

The HEMM is a process which, by applying a high energy to reactants through high rotational force, can atomize powder as well as induce a chemical reaction in the reactants through maximized dispersion between powder particles. The HEMM may be achieved by a Mechanofusion system or a Nobilta device. Mechanofusion is a method of forming a mixture through strong physical rotational force in a dry state, which creates electrostatic adhesion force between constitutive components. Through this process, it may be possible to atomize the compound represented by Formula 1 and obtain particle powder characterized by uniform distribution.

The particles may have an average particle diameter of about 1 nm to about 100 μm, or about 5 nm to about 80 μm.

The HEMM may be, for example, high-energy ball milling. The high-energy ball milling may be performed by, for example, a vibratory-mill, a Z-mill, a planetary ball-mill, an attrition-mill, a SPEX mill, a vibratory mill, a low-temperature grinder, a friction mill, a shaker mill, a stirring ball mill, a mixer ball mill, vertical and horizontal attritors, or the like, and the high-energy ball-milling may be performed by any or/and ball-milling devices available for high-energy ball-milling in the art.

HEMM devices are commercially available and may include but are not limited to, for example, SPEX CertiPrep Group LLC (8000 M Mixer/Mill®, etc.), Zoz GmbH (Simoloyer®), Retsch GmbH (Planetary Ball Mill PM) 200/400/400 MA), and Union Process Inc. (Attritor®).

The HEMM may be performed with, for example, Pulverisette 7 Premium line equipment. Such high-energy milling may significantly reduce the particle size of the compound represented by Formula 1 and facilitate reactions between these particles, and thus may allow a ceramic solid electrolyte to be prepared within a short time.

The grinding balls used during high-energy ball-milling may be stainless steel beads or zirconia beads (ZrO₂), which may have a particle size, without being limited to, in a range of about 0.5 millimeters (mm) to about 20 mm. The pulverization time by HEMM may be about 0.5 hours to about 150 hours.

The HEMM may be performed in an inert atmosphere, and the inert atmosphere may be an atmosphere that is substantially free of oxygen. For example, the inert atmosphere may be an atmosphere containing nitrogen, argon, neon, or a combination thereof. The HEMM may be carried out in a dry manner (e.g., without solvent) for about 0.5 hours to about 1,000 hours, about 0.5 hours to about 100 hours, about 1 hours to about 30 hours, about 1.5 hours to about 20 hours, or about 2 hours to about 15 hours. The HEMM may be performed, for example, in an inert atmosphere in a dry manner at rate of about 300 revolutions per minute (rpm) to about 10,000 rpm, about 350 rpm to about 5,000 rpm, or about 370 rpm to about 1,000 rpm. In a high-energy ball-milling process, the temperature may increase up to 200° C. and the pressure may be an order of 6 gigapascals (GPa) during ball-milling.

As described above, through such high-energy milling, the constitutive components may become fine in size, which facilitates reactions between these components such that the preparation of a solid electrolyte may be possible within a short time.

By the HEMM, the particle size of the milled product may become about 1 nm to about 100 μm, about 10 nm to about 80 μm, about 100 nm to about 50 μm, about 500 nm to about 30 μm, about 1 μm to about 10 μm, or about 1 μm to about 5 μm.

A mechanochemical reaction may be, for example, an exothermic reaction. The reaction to form a solid electrolyte from a solid electrolyte precursor including a compound represented by Formula 1 may be an exothermic reaction. A temperature of the exothermic reaction may be, for example, about 100° C. to about 500° C., about 100°° C. to about 400° C., about 100° C. to about 300° C., or about 100° C. to about 200° C. Mechanical milling may be performed, for example, by a dry method without using solvents or the like. Because the mechanical milling can be performed by a dry method, post-treatment processes, such as solvent removal, may be omitted.

The product obtained through the aforementioned high-energy mechanical milling may have an amorphous state. The product having an amorphous state may be subjected to a heat treatment at a temperature of 600° C. or less and at a temperature of 200° or greater for about 0.5 hour to about 30 hours, to produce a garnet ceramic solid electrolyte. As such, if heat treating the product having an amorphous state at a low-temperature, a solid electrolyte that has high ionic conductivity while having excellent stability may be obtained without any additional sintering process.

If necessary, an organic solvent may be added during the high-energy mechanical milling. By performing bead-mill pulverization within an organic solvent, the pulverized products may prevent dissolution of lithium (Li) components, and a fine pulverized product having a uniform composition may be obtained.

The organic solvent may be one or more of an alcohol-based solvent, a ketone-based solvent, an ester-based solvent, a glycol ether-based solvent, a hydrocarbon-based solvent, an ether solvent, a glycol-based solvent, or an amine-based solvent.

For example, the organic solvent may be at least one of an alcohol-based solvent, such as isopropyl alcohol, toluene, methanol, ethanol, butanol, hexanol, benzyl alcohol, or isopropyl alcohol; a ketone-based solvent, such as acetone, methyl ethyl ketone, methyl isobutyl ketone, or cyclohexanone; an ester-based solvent, such as methyl acetate, ethyl acetate, or butyl acetate; a glycol ether-based solvent, such as propylene glycol monomethyl ether, ethylene glycol monoethyl ether, ethyl glycol monobutyl ether, 3-methoxy-3-methyl-1-butanol, or diethylene glycol monobutyl ether; a hydrocarbon-based solvent, such as benzene, toluene, xylene, cyclohexane, methylcyclohexane, ethylcyclohexane, mineral oil, n-paraffin, or iso-paraffin; an ether solvent, such as 1,3-dioxolane, 1,4-dioxane, or tetrahydrofuran; a glycol-based solvent, such as ethylene glycol, diethylene glycol, propylene glycol, or polyethylene glycol; or an amine-based solvent, such as monoethanolamine, diethylamine, triethanolamine, n-methyl-2-pyrrolidone, 2-amino-2-methyl-1-propanol, or N, N-dimethylformamide. If water, which has high hydrophilicity, is used as the solvent, lithium (Li) is dissolved, which may cause degradation of LLZO crystallinity. However, the aforementioned organic solvents have high hydrophobicity such that they do not dissolve lithium (Li) and thus make it easier to maintain LLZO crystallinity. Furthermore, by using toluene as the organic solvent, the formation of impurity phases may be further suppressed.

Hereinbelow, examples and comparative examples of the present disclosure will be described. However, the following examples are merely an example of the present disclosure, and the present closure is not limited to the following examples.

### EXAMPLES

### Preparation of Solid Electrolyte Precursor

### Comparative Example 1: Crystalline Mixed Solid Electrolyte Precursor

Starting materials Li₂O, La₂O₃, ZrO₂, and Ta₂O₅ were combined in a stoichiometric ratio of 3.25:1.5:1.5:0.25, and Li₂O was added thereto such that the Li content of the mixture was 10 mole percent (mol %). The mixture was then mixed for 30 minutes to produce a crystalline mixed solid electrolyte precursor.

### Comparative Example 2: Solid Electrolyte Precursor

The material prepared in Comparative Example 1 was introduced into a high-energy ball mill loaded with silicon nitride (SiN) balls having a diameter of 5 mm and 10 mm, and then was dry-milled at 370 rpm for 5 minutes, to produce a solid electrolyte precursor.

### Example 1: Amorphous Solid Electrolyte Precursor

A mixture containing the starting materials Li₂O, La₂O₃, ZrO₂, and Ta₂O₅ in a stoichiometric ratio of 3.25:1.5:1.5:0.25 was dry-milled at 370 rpm for 15 hours by a high-energy ball mill loaded with 5 mm to 10 mm-silicon nitride (SiN) balls, to produce an amorphous solid electrolyte precursor.

### Example 2: Amorphous Solid Electrolyte Precursor

The starting materials Li₂O, La₂O₃, ZrO₂, and Ta₂O₅ were combined in a stoichiometric ratio of 3.25:1.5:1.5:0.25, and Li₂O was added thereto, such that the Li content of the mixture was 10 mol %. Then, the mixture was dry-milled at 370 rpm for 15 hours by a high-energy ball mill loaded with 5 mm to 10 mm-silicon nitride (SiN) balls, to produce an amorphous solid electrolyte precursor.

### Example 3: Amorphous Solid Electrolyte Precursor

The starting materials Li₂O, La₂O₃, ZrO₂, and Ta₂O₅ were combined in a stoichiometric ratio of 3.25:1.5:1.5:0.25, and Li₂O was added thereto, such that the Li content of the mixture was 20 mol %. Then, the mixture was dry-milled at 370 rpm for 15 hours by a high-energy ball mill loaded with 5 mm-to 10 mm-silicon nitride (SIN) balls, to produce an amorphous solid electrolyte precursor.

### Example 4: Amorphous Solid Electrolyte Precursor

The material prepared in Comparative Example 1 was introduced into a high-energy ball mill loaded with silicon nitride (SiN) balls having a diameter of 5 mm and 10 mm, and then was dry-milled at 370 rpm for 2 hours, to produce an amorphous solid electrolyte precursor.

### Example 5: Amorphous Solid Electrolyte Precursor

The material prepared in Comparative Example 1 was introduced into a high-energy ball mill loaded with silicon nitride (SiN) balls having a diameter of 5 mm and 10 mm, and then was dry-milled at 370 rpm for 5 hours, to produce an amorphous solid electrolyte precursor.

### Evaluation Example 1: Structures and Full Width at Half Maximum of Solid Electrolyte Precursors—X-Ray Diffraction Analyses

X-ray diffraction (XRD) spectra were obtained for XRD analyses by using X'pert pro (PANalytical) using CuKα radiation (1.54056 angstroms, Å).

### (1) XRD Analysis According to Dry-Milling Time

XRD spectra obtained from the (mixed) solid electrolyte precursors prepared in Comparative Examples 1 and 2, and Examples 2, 4, and 5 are shown in FIG. 1. For the (mixed) solid electrolyte precursors prepared in these Comparative Examples and Examples, their respective structures and Pᵣ (%), which is the proportion of the area Pb of peaks having a full width at half maximum (FWHM) of 0.01° to 0.5° to the total area Pₐ of all peaks at a diffraction angle of 10° 2θ to 90° 2θ, are shown in Table 1.

TABLE 1

| Item | Structure | Pᵣ** (%) |
|---|---|---|
| Comparative Example 1 | Crystalline | >95 |
| Comparative Example 2 | Crystalline | 31 |
| Example 2 | Amorphous | <1 |
| Example 4 | Amorphous | <5 |
| Example 5 | Amorphous | <2 |

**Pᵣ is a value obtained from [(P_{b})/(Pₐ) × 100(%)] wherein Pₐ is the total area of all peaks at a diffraction angle of 10°2θ to 90°2θ, and P_{b} is the area of peaks having FWHM of 0.01° to 0.5° in the same range of diffraction angle as Pₐ.

Referring to Table 1 and FIG. 1, in the mixed solid electrolyte precursor prepared in Comparative Example 1, which had no dry milling, and the solid electrolyte precursor prepared in Comparative Example 2, which was subjected to 5 minutes of dry milling, peaks had FWHM of 0.01° to 0.5° at diffraction angles of 23°±1° 2θ, 28.5°±1° 2θ, and 30.1°±1° 2θ, and Pᵣ was 31% or greater. It could be confirmed that the mixed solid electrolyte precursor prepared in Comparative Example 1 and the solid electrolyte precursor prepared in Comparative Example 2 both have a crystalline structure.

Meanwhile, in the solid electrolyte precursors prepared in Examples 4 and 5, which were subjected to dry milling for 2 hours and 5 hours, respectively, peaks had FWHM of about 0.74° at diffraction angles of 23°±1° 2θ and/or 27°±1° 2θ, and Pᵣ was 10% or less. In the solid electrolyte precursor prepared in Example 2, which had undergone dry-milling for 15 hours, no peak was observed. From this result, it could be confirmed that the solid electrolyte precursors prepared in Examples 2, 4, and 5, which had undergone dry-milling for 2 hours or more, all have an amorphous structure.

### (2) XRD Analyses According to the Amount of Li Added

XRD spectra obtained from the solid electrolyte precursors prepared in Comparative Example 1 and Examples 1, 2, and 3 are shown in FIGS. 1 and 2. The structure, amount of lithium added, and Pᵣ (%) of each of the solid electrolyte precursors prepared in these Comparative Example and Examples are shown in Table 2.

TABLE 2

| | | Amount of Li added | |
|---|---|---|---|
| Item | Structure | (mol %) | Pᵣ**(%) |
| Comparative Example 1 | Crystalline | 10 | >95 |
| Example 1 | Amorphous | 0 | <1 |
| Example 2 | Amorphous | 10 | <1 |
| Example 3 | Amorphous | 20 | <1 |

**The definition of Pᵣ is the same as in Table 1.

Referring to Table 2, the solid electrolyte precursors prepared in Comparative Example 1 and Examples 1, 2, and 3 were found to maintain their original crystalline or amorphous structures, regardless of the amount of Li added. Referring to FIG. 2, no peaks having FWHM of 0.01° to 0.5° were observed in Examples 1, 2, and 3. From this result, it could be confirmed that the solid electrolyte precursors prepared in Examples 1,2, and 3 all had an amorphous structure.

### Evaluation Example 2: Structure of Solid Electrolyte Precursor-Differential Scanning Calorimetry Analysis

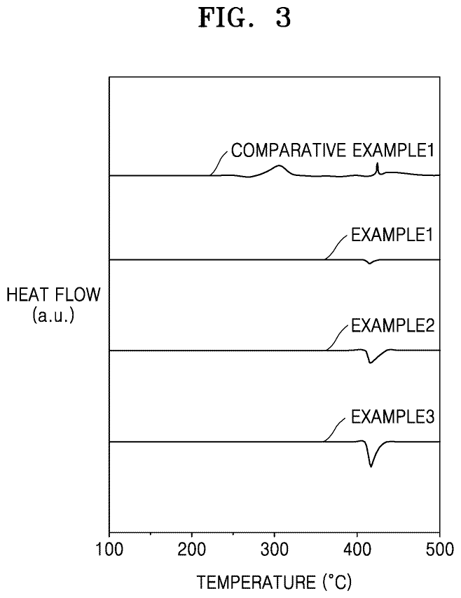

Differential scanning calorimetry (DSC) spectra obtained from the solid electrolyte precursors prepared in Comparative Example 1 and Examples 1, 2, and 3 are shown in FIG. 3.

For DSC spectrum analysis, by using a DSC differential scanning calorimeter manufactured by PerkinElmer, measurements were taken in an N₂ atmosphere from room temperature up to 500° C. at a heating rate of 10° C./min.

The DSC spectrum is an “endo up” spectrum, which shows a peak in an upward direction for an endothermic reaction and a peak in a downward direction for an exothermic reaction.

Referring to FIG. 3, the solid electrolyte precursor prepared in Comparative Example 1 shows an upward peak at about 430° C. The solid electrolyte precursors prepared in Examples 1, 2, and 3 show a downward peak at about 425° C.

From this result, it could be confirmed that in the solid electrolyte precursor prepared in Comparative Example 1, no garnet crystallization (cubic phase) has occurred at a temperature of 500° C. or less, whereas in the solid electrolyte precursors prepared in Examples 1, 2, and 3, garnet crystallization (cubic phase) has taken place at a temperature of 500° C. or less.

### Evaluation Example 3: Cubic Phase Crystalline Characterization—X-Ray Diffraction Analysis

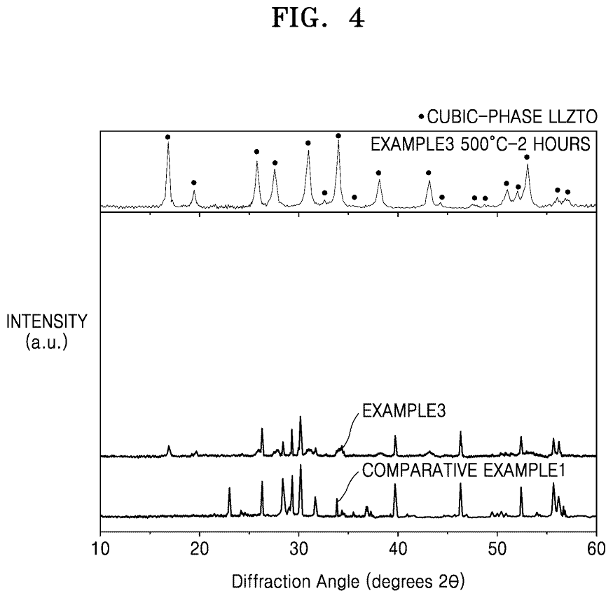

XRD spectra obtained from the solid electrolytes prepared using the solid electrolyte precursors prepared in Comparative Example 1 and Example 3, respectively, are shown in FIG. 4. The XRD spectra were obtained by X'pert pro (PANalytical) using CuKα radiation (1.54056 Å).

Referring to FIG. 4, it was found that in the solid electrolyte prepared in Comparative Example 1, pure cubic-phase crystalline peaks were not formed, and pure cubic crystalline peaks were observed after the heat-treatment at 1,000° C. for 12 hours. In the solid electrolyte prepared in Example 3, a pure cubic crystalline peak was observed after the heat-treatment at 500° C. for 2 hours.

From this result, it could be confirmed that in the solid electrolyte precursor prepared in Comparative Example 1, the cubic-phase crystallization does not occur at a temperature of 500° C. or less, whereas the cubic-phase crystallization does occur at a temperature of 500° C. or less in the solid electrolyte precursor prepared in Example 3. This result shows that a crystalline garnet oxide solid electrolyte including a cubic phase can be synthesized from the solid electrolyte precursor prepared in Example 3 at a temperature of 500° C. or less.

A solid electrolyte precursor according to an aspect of the disclosure includes a compound represented by Formula 1 and has an amorphous phase as a major phase, and at a diffraction angle of 10° 2θ to 90° 2θ in an X-ray diffraction (XRD) spectrum, the proportion of the area Pb of peaks having a full width at half maximum of 0.01° to 0.5° to a total area Pₐ of all peaks is 10% or less. The solid electrolyte precursor may be used to synthesize a crystalline garnet oxide at a temperature of 500° C. or less.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A solid electrolyte precursor, comprising:
a compound represented by Formula 1, wherein the compound comprises an amorphous structure and the amorphous phase is contained in an amount of at least 50 volume percent based on a total volume of the solid electrolyte precursor,
wherein, when the solid electrolyte precursor is analyzed by X-ray diffraction using Cu Kα radiation, at a diffraction angle of 10° 2θ to 90° 2θ a proportion of an area P_{b} of peaks having a full width at half maximum of 0.01° to 0.5° to a total area Pₐ of all peaks is 10% or less
(LiₓAₐ)(La_{y}B′_{b})(Zr_{z}C′_{c})O_{12+δ} Formula 1
wherein in Formula 1,
A is a monovalent cation, a divalent cation, a trivalent cation, or a combination thereof,
B′ is a monovalent cation, a divalent cation, a trivalent cation, or a combination thereof,
C′ is a monovalent cation, a divalent cation, a trivalent cation, a tetravalent cation, a pentavalent cation, a hexavalent cation, or a combination thereof, and
6≤x≤8, 0≤a≤2, 2≤y≤3, 0≤b≤1, 0<z≤2, 0≤c≤2, and −1≤δ≤1.

2. The solid electrolyte precursor of claim 1,
wherein at a diffraction angle of 10° 2θ to 90° 2θ in the X-ray diffraction spectrum, the proportion of the area P_{b} of peaks having a full width at half maximum of 0.01° to 0.5° to the total area Pₐ of all peaks is 1% or less.

3. The solid electrolyte precursor of claim 1,
wherein an exothermic peak is at a temperature of 600° C. or less when the solid electrolyte precursor is analyzed by differential scanning calorimetry.

4. The solid electrolyte precursor of claim 1,
wherein, when analyzed by differential scanning calorimetry, a phase change from an amorphous structure to a garnet crystal structure occurs at a temperature of 600° C. or less.

5. The solid electrolyte precursor of claim 4,
wherein the garnet crystal structure comprises 8-coordinated dodecahedral BO₈ and 6-coordinated octahedral CO₆, and
in the garnet crystal structure, a Li site and an A site are each independently a tetrahedral interstitial site, an octahedral interstitial site, or a distorted 4-coordinated interstitial site.

6. The solid electrolyte precursor of claim 1,
wherein the compound represented by Formula 1 comprises a compound represented by Formula 2:
(LiₓAₐ)(La_{y}B′_{b})(Zr_{z}C′_{c})O_{12+δ} Formula 2
wherein in Formula 2,
A is a trivalent cation,
B′ is Ca, Sr, Ce, Ba, or a combination thereof,
C′ is Al, W, Nb, Ta, or a combination thereof and
6>x≤8, 0≤a≤2, 2≤y≤3, 0≤b≤1, 0<z≤2, 0≤c≤2, and −1≤δ≤1.

7. The solid electrolyte precursor of claim 1,
wherein the compound represented by Formula 1 comprises a compound represented by Formula 3:
Liₓ(La_{y}B′_{b})(Zr_{z}C′_{c})O_{12+δ} Formula 3
wherein in Formula 3,
B′ is Ca, Sr, Ce, Ba, or a combination thereof,
C′ is Al, W, Nb, Ta, or a combination thereof, and
6≤x≤8, 0≤a≤2, 2≤y≤3, 0<z≤2, and −1≤δ≤1.

8. The solid electrolyte precursor of claim 1,
wherein the compound represented by Formula 1 comprises a compound represented by Formula 4:
Li₆₊ₓLa₃Zr₂₋ₐC′ₐO_{12+δ} Formula 4
wherein in Formula 4,
C′ is Ga, W, Nb, Ta, Al, or a combination thereof, and
0≤x≤2, 0≤a≤0.7, and −1≤δ≤1.

9. The solid electrolyte precursor of claim 1,
wherein the solid electrolyte precursor is in a powder form.

10. A solid electrolyte comprising:
a crystalline product of heat treating the solid electrolyte precursor according to claim 1.

11. The solid electrolyte of claim 10,
wherein the crystalline phase comprises a cubic phase,
wherein the cubic phase is 60 volume percent or greater of a total volume of the crystalline phase.

12. A lithium battery comprising:
a solid electrolyte layer between a cathode layer and an anode layer,
wherein the cathode layer, the anode layer, the solid electrolyte layer, or a combination thereof comprise the solid electrolyte of claim 11.

13. A method of preparing a solid electrolyte, the method comprising:
high-energy mechanical milling of a solid electrolyte precursor comprising a compound represented by Formula 1 to form a milled product; and
heat treating the milled product at a temperature of 600° C. or less to form a solid electrolyte;
wherein the solid electrolyte precursor has an amorphous phase and the amorphous phase is contained in an amount of at least 50 volume percent based on a total volume of the solid electrolyte precursor, and at a diffraction angle of 10° 2θ to 90° 2θ in an X-ray diffraction spectrum, the proportion of an area P_{b} of peaks having a full width at half maximum of 0.01° to 0.5° to a total area Pₐ of all peaks is 10% or less.
(LiₓAₐ)(La_{y}B′_{b})(Zr_{z}C′_{c})O_{12+δ} Formula 1
wherein in Formula 1,
A is a monovalent cation, a divalent cation, a trivalent cation, or a combination thereof,
B′ is a monovalent cation, a divalent cation, a trivalent cation, or a combination thereof,
C′ is a monovalent cation, a divalent cation, a trivalent cation, a tetravalent cation, a pentavalent cation, a hexavalent cation, or a combination thereof, and
6≤x≤8, 0≤a≤2, 2≤y≤3, 0≤b≤1, 0<z≤2, 0≤c≤2, and −1≤δ≤1.

14. The method of claim 13,
wherein when the milled product is heat treated in a differential scanning calorimeter, an exothermic peak is observed by differential scanning calorimetry at a temperature of 600° C. or less,.

15. The method of claim 13,
wherein when the milled product is heat treated at a temperature of 600° C. or less, an amorphous structure of the solid electrolyte precursor undergoes a phase transition to a garnet crystal structure.

16. The method of claim 15,
wherein the garnet crystal structure comprises 8-coordinated dodecahedral BO₈ and 6-coordinated octahedral CO₆, and
a Li site and an A site are each independently a tetrahedral interstitial site, an octahedral interstitial site, or a distorted 4-coordinated interstitial site.

17. The method of claim 13,
wherein the compound represented by Formula 1 comprises a compound represented by Formula 4:
Li₆₊ₓLa₃Zr₂₋ₐC′ₐO_{12+δ} Formula 4
wherein in Formula 4,
C′ is Ga, W, Nb, Ta, Al, or a combination thereof, and
0≤x≤2, 0≤a≤0.7, and −1≤δ≤1.

18. The method of claim 13,
wherein the high-energy mechanical milling is performed by high-energy ball-milling.

19. The method of claim 13,
wherein the high-energy mechanical milling is performed for about 2 hours to about 15 hours.

20. The method of claim 13,
wherein the solid electrolyte comprises a crystalline phase that is a cubic phase,
wherein the cubic phase is 60 weight percent or greater of a total weight of the crystalline phase.
